(19) United States
(12) Patent Application Publication
(10) Pub. No.: US 2012/0315125 A1
(43) Pub. Date: Dec. 13, 2012

(54) TURBINE BLADES WITH MIXED BLADE LOADING

(75) Inventors: Walter M. Presz, Wilbraham, MA (US); Michael J. Werle, West Hartford, CT (US); Robert H. Dold, Monson, MA (US); Timothy Hickey, East Longmeadow, MA (US)

(73) Assignee: FloDesign Wind Turbine Corp., Waltham, MA (US)

(21) Appl. No.: 13/481,505

(22) Filed: May 25, 2012

Related U.S. Application Data
(60) Provisional application No. 61/490,841, filed on May 27, 2011.

(51) Int. Cl. F03D 1/04; F01D 5/14; F01D 1/04; F03D 1/06

(52) U.S. Cl. 415/1; 416/223 R; 415/220

(57) ABSTRACT

An unevenly loaded turbine blade is disclosed including a first region configured for extracting power from a fluid flow and a second region configured for adding power to the fluid flow. The power extracted from the fluid flow is typically greater than the power added to the fluid flow resulting in a net power extracted for the blades. The addition of power to the fluid flow advantageously results in localized injections of high velocity fluid flow which provide distributed mixing of wake and tip vortices along the length of the blade.

### CROSS-REFERENCE TO RELATED APPLICATIONS

This application claims priority to U.S. Provisional Application Ser. No. 61/490,841, filed May 27, 2011, the entirety of which is incorporated by reference herein.

### TECHNICAL FIELD

The present disclosure relates to turbine rotor blades of a particular structure, and to shrouded turbines incorporating such blades. More specifically, the present rotor blade design comprises uneven loading (also known as “asymmetrical loading” or “unbalanced loading”).

### BACKGROUND

Horizontal axis turbines (HAWTs) typically include two to five bladed rotors joined at a central hub. A conventional HAWT blade is commonly designed to provide substantially even blade loading across a power-extracting region of the blade. One common mathematical tool for predicting and evaluating blade performance is blade element theory (BET). BET treats a blade as a set of component elements (also known as “stations”). Each component element may be defined by a radial cross section of the blade (known as an airfoil) at a radial position (r) relative to the axis of rotation and width of the element (dr). Applying BET analysis, even blade loading may be characterized as each component element of the blade along the power-extracting region having a same pressure differential (Δp) during operation. Note that Δp/ρ=P/\dot{m}, wherein ρ is fluid density, P is power and \dot{m} is mass flow rate. Given that fluid density is typically constant, pressure differential may be assumed proportional to power over mass flow rate. Thus, even blade loading may also typically be characterized as each component element of the blade along the power-extracting region exhibiting a same power extracted per mass flow rate. Note that a conventional HAWT blade may also include one or more non-power-extracting regions. For example, conventional HAWT blades are often tapered at the tip and/or root of the blade, for example, to reduce vortices. Such tapered regions or otherwise minimally loaded regions proximal to the tip and/or root of the blade are considered non-power-extracting regions for the purposes of the present disclosure.

Stations are typically designed/configured so as to maximize power extraction across the blade while maintaining a constant power extracted per mass flow rate. Mass flow rate is defined as \dot{m}=/ρυA, wherein ρ is fluid density, υ is flow velocity and A is the flow area (the “rotor swept area”). Flow area for each station may be calculated as A=2πdr. Note that station flow area increases as a function of radial position impacting mass flow rate. Thus, the airfoil for each station is typically designed to maintain even loading while accounting for different mass flow rates. Parameters which may be adjusted to ensure even loading for different mass flow rates include pitch (also known as the “angle of attack”) and/or airfoil shape, for example, characterized by chord length, maximum thickness (sometimes expressed as a percentage of cord length), mean camber line, and/or the like. Airfoils for a conventional evenly loaded HAWT blade typically exhibit longer chord lengths and greater pitch toward the root than toward the tip to account for a higher mass flow rate toward the tip (note that for conventional unshrouded HAWTs, there is little difference between fluid velocity at the center of the rotor plane and fluid velocity at the perimeter of the rotor plane.

Recent development efforts have seen the implementation of shrouded turbines, for example, to reduce the affect of fringe vortices and/or to increase fluid flow velocity. One example of a shrouded mixer-ejector wind turbine has been described in U.S. patent application Ser. No. 12/054,050, which issued as U.S. Pat. No. 8,021,100 and is incorporated herein in its entirety. Development of shrouded turbines for power extraction is still in its infancy. Thus, there is a need for new and improved blades designed and optimized to work within a shrouded turbine environment. These and other needs are addressed by way of the present disclosure.

### BRIEF DESCRIPTION

The present disclosure relates to novel turbine blade designs characterized by uneven blade loading. The present disclosure further relates to systems and methods for utilizing and methods for manufacturing unevenly loaded turbine blades. Uneven blade loading teaches away from the norm of the industry and is particularly useful for taking advantage of non-uniform flow profiles, e.g. such as may be created by a shroud. Indeed, as recognized herein unevenly loaded blades may provide particular advantages, for example, greater power extraction and/or greater efficiency relative to conventional evenly loaded blades particularly in a shrouded turbine environment or in other turbine environments where fluid flow velocity is non uniform across the rotor plane.

In an example embodiment, an unevenly loaded turbine blade is disclosed including a first region configured for extracting power from a fluid flow and a second region configured for adding power to the fluid flow. The power extracted from the fluid flow is typically greater than the power added to the fluid flow resulting in a net power extracted for the blades. In one embodiment, an unevenly loaded turbine blade may be designed to extract power from a fluid stream along 70%-80% of its length while adding power to a fluid stream along 20%-30% of its length. The generating of power into the fluid stream may advantageously result in localized injections of high velocity fluid flow which provide distributed mixing of wake and tip vortices along the length of the blade.

One skilled in the art will readily recognize that the unevenly loaded rotor blades of the present disclosure may be employed in conjunction with numerous turbines including those that are at least in part shrouded.

One suitable example is a cyclonic turbine wherein a cyclonic shroud may be in close proximity to or surround the rotor. A cyclonic turbine employs high speed rotating fluid flow established within a cylindrical or conical container called a cyclone in combination with at least one highly cambered ringed airfoil to improve turbine efficiency. The optimum blade design for the cyclonic turbine system is a function of two factors: the speed up of the flow at the rotor station and the energy addition to the rotor wake flow at the exit of the turbine. These two results reflect the physics of the system. The cambered shrouds and cyclone effect bring more flow through the rotor allowing more energy extraction due to higher flow rates. The higher velocities at the rotor plane can be described through normal induction factor analyses in wind turbine blade design. The power extraction (total pressure extraction profile) is varied with high power extraction at the top ⅓ of the blade and lower power extraction or power injection at the blade root section.

A cyclonic turbine in accordance with one embodiment provides increased velocity of the fluid stream at the rotor plane in comparison to the velocity of the fluid stream at the center of the rotor plane. A blade design that accommodates more energy extraction per unit mass flow rate at the perimeter and either less energy extraction per unit mass flow rate, or energy injection per unit mass flow rate at the center of the rotor plane, known as uneven blade loading, is better suited to derive power from the fluid stream than one that is symmetrically loaded.

In other exemplary embodiments, mixed blade loading (negative and positive blade loading in different regions of a same blade) may be used to mitigate the effect of vortices on turbine operations and provide more efficient downstream mixing of fluids.

As understood by one skilled in the art, the aerodynamic principles of a turbine are not restricted to a specific fluid, and may apply to any fluid, defined as any liquid, gas or combination thereof and therefore includes water as well as air. In other words, the aerodynamic principles of a wind turbine apply to hydrodynamic principles in a water turbine.

These and other non-limiting features or characteristics of the present disclosure will be further described below.

### BRIEF DESCRIPTION OF THE DRAWINGS

The following is a brief description of the drawings, which are presented for the purposes of illustrating the disclosure set forth herein and not for the purposes of limiting the same.

FIG. 1 is a front right perspective view of an example horizontal wind turbine of the prior art.

FIG. 2 is a perspective view depicting delineated cross sections that represent stations of one of the rotor blades of the turbine of FIG. 1.

FIG. 3 is an orthographic end view of the delineated cross sections that represent each station of the rotor blade of FIG. 2.

FIG. 4 illustrates even blade loading of a power-extracting region of the rotor blade of FIGS. 2 and 3.

FIG. 5 is a graphical representation of the pressure differential per station (blade loading) represented in FIG. 4.

FIG. 6 is a front perspective view of an exemplary turbine embodiment of the present disclosure.

FIG. 7 is a cross section of the turbine represented in FIG. 6.

FIG. 8 is a perspective view depicting delineated cross sections that represent the stations of one of the rotor blades of the turbine of FIGS. 6 and 7.

FIG. 9 is an orthographic end view of the delineated cross sections that represent each station of the rotor blade of FIG. 8.

FIG. 10 illustrates uneven blade loading of the rotor blade of FIGS. 8 and 9.

FIG. 11 is a graphical representation of the pressure differential per station (blade loading) represented in FIG. 10.

FIG. 12 is a cross section of a further exemplary turbine embodiment of the present disclosure.

FIG. 13 is a perspective view depicting delineated cross sections that represent the stations of one of the rotor blades of the turbine of FIG. 12.

FIG. 14 is an orthographic end view of the delineated cross sections that represent each station of the rotor blade of FIG. 13.

FIG. 15 illustrates mixed blade loading of the rotor blade of FIGS. 13-14.

FIG. 16 is a graphical representation of the pressure differential per station (blade loading) represented in FIG. 15.

FIG. 17 is a graphical representation of the pressure differential per station (blade loading) for a further exemplary blade embodiment.

FIG. 18 is a front perspective view of a further exemplary embodiment turbine embodiment of the present disclosure.

FIG. 19 is a partial cross section of the turbine represented in FIG. 18.

FIG. 20 is an orthographic, side cross section view of the turbine of FIG. 18.

FIG. 21 is a perspective view depicting delineated cross sections that represent the stations of one of the rotor blades of the fluid turbine of FIG. 18-20.

FIG. 22 is an orthographic end view of the delineated cross sections that represent each station of the rotor blade of FIG. 21.

FIG. 23 illustrates mixed blade loading of the rotor blade of FIGS. 21-22.

FIG. 24 is a graphical representation of the pressure differential per station (blade loading) represented in FIG. 23.

FIG. 25 is a cross section of another example embodiment of a turbine rotor blade of the present disclosure.

FIG. 26 is a cross section of another example embodiment of a turbine rotor blade of the present disclosure.

FIG. 27 is a cross section of another example embodiment of a turbine rotor blade and shroud of the present disclosure.

FIG. 28 is a detailed cross section of the example turbine rotor blade of FIG. 27.

FIG. 29 depicts an exemplary turbine park.

FIGS. 30-32 are front perspective views of a further exemplary shrouded turbine, in accordance with embodiments of the present disclosure.

### DETAILED DESCRIPTION

A more complete understanding of the components, processes, and apparatuses disclosed herein can be obtained by reference to the accompanying figures. These figures are intended to demonstrate the present disclosure and are not intended to show relative sizes and dimensions or to limit the scope of the disclosed embodiment(s).

Although specific terms are used in the following description, these terms are intended to refer only to particular structures in the drawings and are not intended to limit the scope of the present disclosure. It is to be understood that like numeric designations refer to components of like function.

A value modified by the term “about” or the term “substantially” should be interpreted as disclosing both the stated value as well as a range of values proximal to the stated value within the meaning dictated by the context and as would readily be understood by one of ordinary skill in the art. For example, a value modified by the term “about” or the term “substantially” should be interpreted as disclosing a range of values proximal to the value accounting for at least the degree of error related to the value, for example, based on design/manufacture tolerances and/or measurement errors affected the value.

Turbines may be used to extract energy from a variety of suitable fluids such as air (e.g., wind turbines) and water (e.g., hydro turbines), e.g., to generate electricity. In general, principles relating to turbine design and operation, such as described herein, remain consistent regardless of fluid type. For example, the aerodynamic principles of a wind turbine also apply to hydrodynamic principles of a water turbine. Thus, while portions of the present disclosure may be directed towards one or more example embodiments of turbines it will be appreciated by one of ordinary skill in the art that such teachings may be universally applicable, for example, regardless of fluid type.

A Mixer-Ejector Turbine (MET) provides an improved means of extracting power from flowing fluid. A primary shroud contains a rotor which extracts power from a primary fluid stream. A mixer-ejector pump is included that ingests bypass for use in energizing the primary fluid flow. This mixer-ejector pump may promote turbulent mixing of the aforementioned two fluid streams. This mixing enhances the power extraction from the MET system by increasing the amount of fluid flow through the system, increasing the velocity at the rotor plane for more power availability, and reducing the pressure on down-wind side of the rotor plane and energizing the rotor wake. As understood by one skilled in the art, the aerodynamic principles of a MET are not restricted to a specific fluid, and may apply to any fluid, defined as any liquid, gas or combination thereof and therefore includes water as well as air. In other words, the aerodynamic principles of a mixer ejector wind turbine apply to hydrodynamic principles in a mixer ejector water turbine.

Exemplary rotors, according to the present disclosure, may include a conventional propeller-like rotor, a rotor/stator assembly, a multi-segment propeller-like rotor, or any type of rotor understood by one skilled in the art. In an example embodiment, a rotor may be associated with a turbine shroud, such as described herein, and may include one or more rotor blades, for example, one or more unevenly loaded rotor blades, such as described herein, attached to a rotational shaft or hub. As used herein, the term “blade” is not intended to be limiting in scope and shall be deemed to include all aspects of suitable blades, including those having multiple associated blade segments.

The leading edge of a turbine blade and/or the leading edge of a turbine shroud may be considered the front of the turbine. The trailing edge of a turbine blade and/or the trailing edge of an ejector shroud may be considered the rear of the turbine. A first component of the turbine located closer to the front of the turbine may be considered “upstream” of a second component located closer to the rear of the turbine. Put another way, the second component is “downstream” of the first component.

In an example embodiment, the present disclosure relates to a turbine for extracting power from a non-uniform flow velocity. In one example embodiment, the turbine may be configured for affecting the non-uniform flow velocity in the fluid (for example, the turbine may be a MET including a turbine shroud that is in close proximity to or surrounds a rotor and an ejector shroud that is in close proximity to or surrounds the exit of the turbine shroud). More particularly, the present disclosure relates to the design and implementation (for example, in a shrouded turbine) of unevenly loaded rotor blade(s). In one example embodiment, the tip to hub variation in power extracted per mass flow rate is between 40% and 90%, or in other words, the area toward the tip region of the rotor extracts between 40% and 90% more power per mass flow rate than the area toward the root region at the hub of the rotor blade. Advantageously, the mass-average total pressure drop from the upstream area to the downstream area may remain the same.

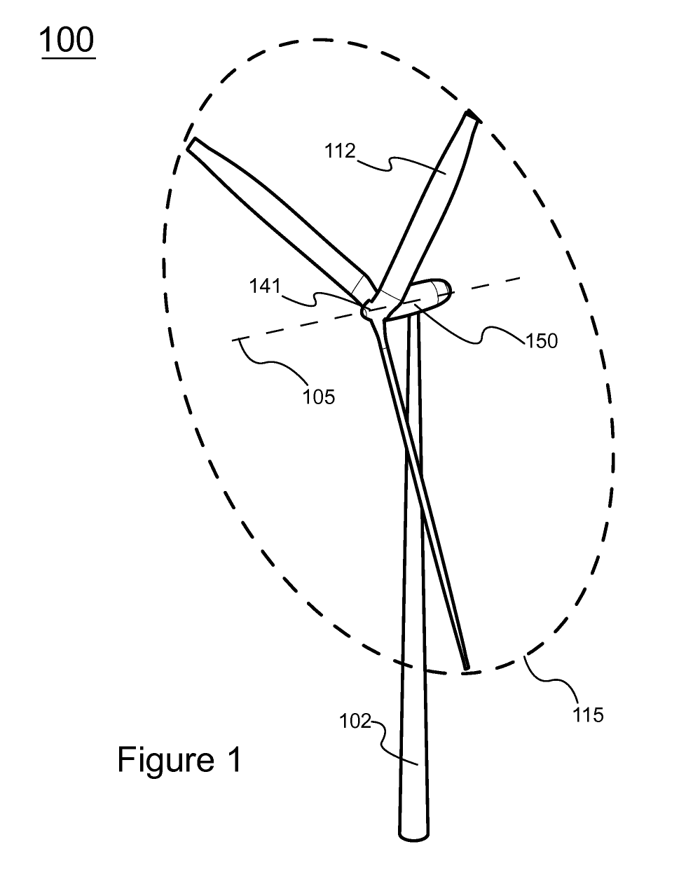

FIG. 1 is a perspective view of an embodiment of a conventional HAWT 100 of the prior art. The HAWT 100 includes rotor blades 112 that are joined at a central hub 141 and rotate about a central axis 105. The hub is joined to a shaft that is co-axial with the hub and with the nacelle 150. The nacelle 150 houses electrical generation equipment (not shown). The rotor plane is represented by the dotted line 115.

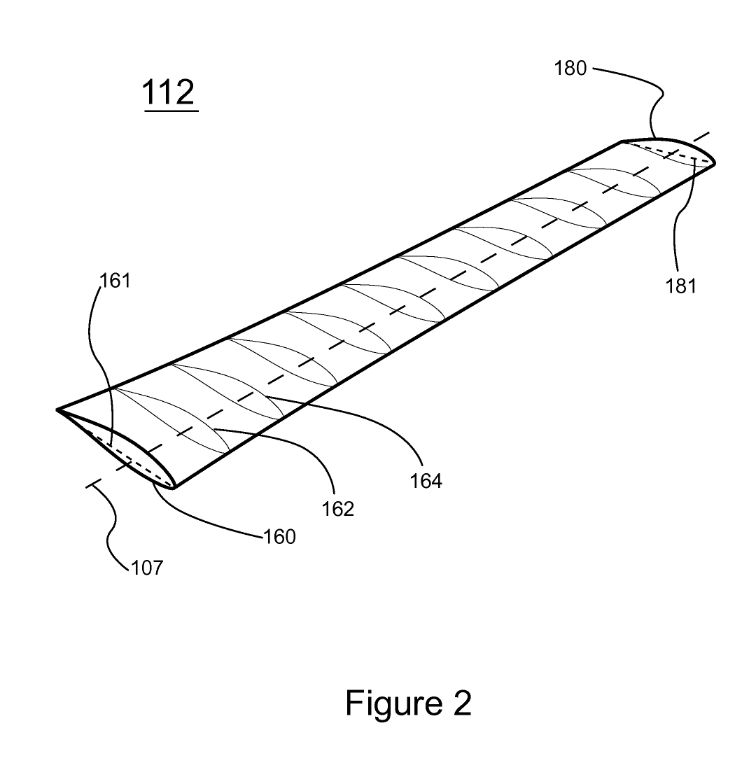

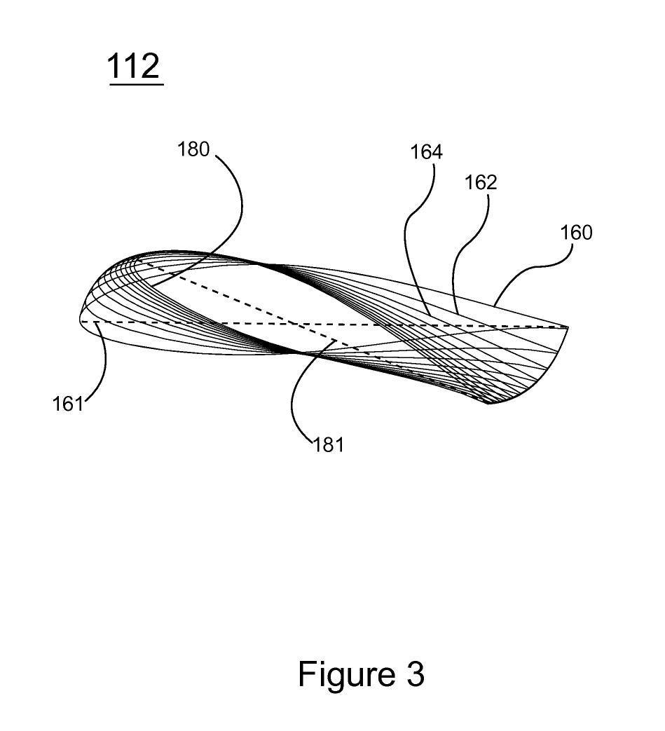

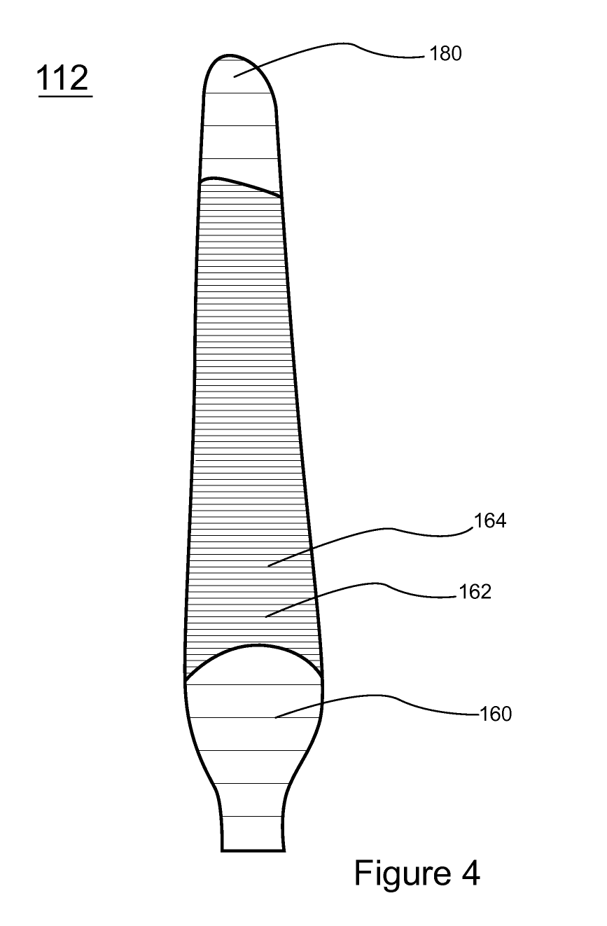

Referring to FIGS. 2-4, an exemplary rotor blade 112, (e.g., for the HAWT 100 of FIG. 1) is shown. Cross sections 160, 162, 164 . . . 180 are delineated at different radial positions relative to the axis of rotation (e.g., relative to the central axis of FIG. 1) along a central blade axis 107. Each cross section 160, 162, 164 . . . 180 represents a station along the blade 112 and defines an airfoil. According to the illustrated embodiment, each airfoil may be characterized based on the length and pitch of a cord between the leading and trailing edges of the airfoil (note this is merely an illustrative embodiment, however, and any number of parameters relating to the shape and/or pitch of the airfoil may be identified and used to characterize the airfoil). Cross section 160 defines chord 161. Similarly, cross section 180 defines chord 181. Referring to FIG. 3, each chord has a length and a pitch as seen in the length and relative pitch angle between chords 161 and 181. The chord length and pitch of each cross section affects the loading on the blade at the corresponding station. FIG. 4, depicts blade loading (Δp) across different regions of the blade 112. Blade loading (Δp) is illustrated using horizontal hash markings wherein the spacing between the hash markings is inversely proportional to blade loading. As depicted in FIG. 4, conventional HAWT blades are designed to have even blade loading at each station across a power-extracting region of the blade 112 when operating in a fluid stream. Note that the blade 112 includes two non-power-extracting regions proximal to the root and tip of the blade (see cross sections 160 and 180, respectively). The non-power extracting regions are identifiable by the sudden minimal blade loading represented in FIG. 4 by sparse horizontal hash marking at the root and tip of the blade 112.

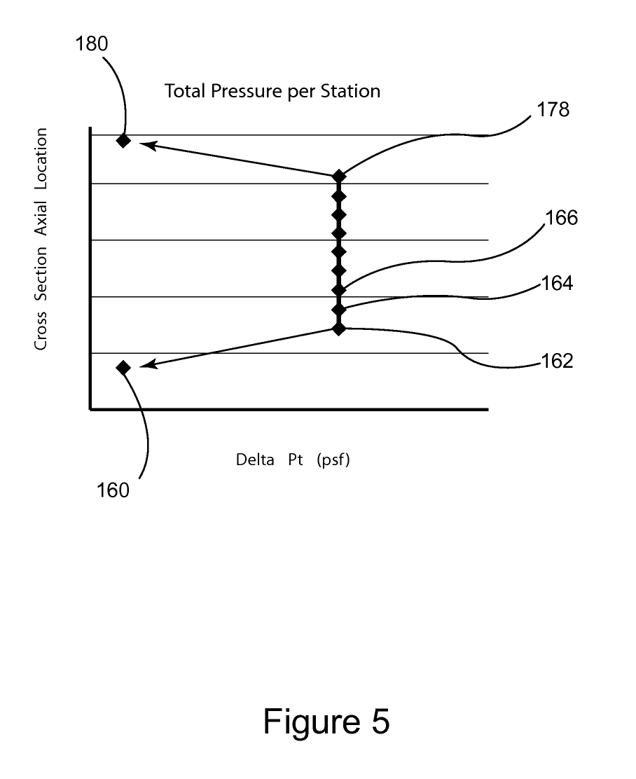

FIG. 5 depicts a graphical representation of blade loading per station as represented in FIG. 4 for blade 112. As noted with respect to FIG. 5 even blade loading is evident for stations in a power-extracting region of the blade 112 (see, e.g., cross sections 162, 164, 166 and 178). Minimal blade loading is evident for stations in non-energy extracting regions of the blade 112 near the root and tip (see, e.g., cross sections 160 and 180, respectively). The position of the cross sections 160, 162, 164 . . . 180 along the axis 107 is represented along the vertical axis of the graph. Blade loading, characterized by a pressure differential (Δp) in pounds per square foot (psf) is represented along the horizontal axis of the graph. The vertical alignment cross sections from the power-extracting region of the blade 112 represents substantially identical, or even, blade loading.

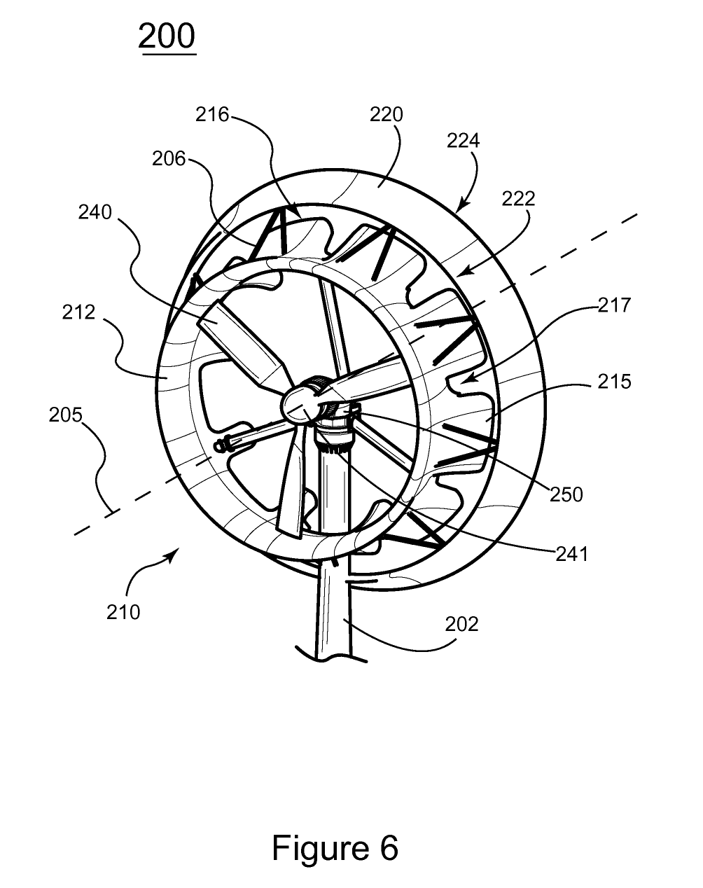

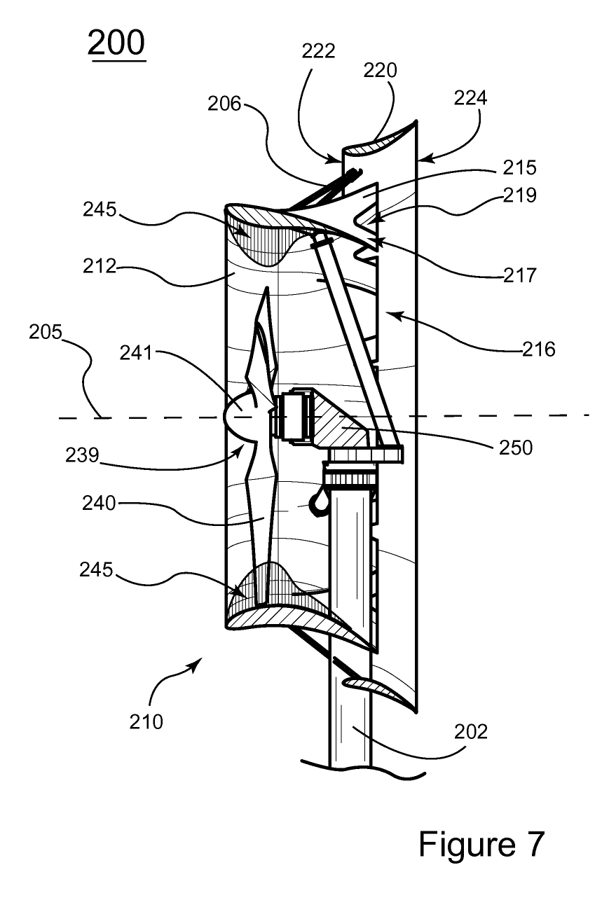

FIG. 6 is a perspective view of an exemplary embodiment of a shrouded turbine 200 of the present disclosure. FIG. 7 is a cross sectional view of the shrouded turbine of FIG. 6. Referring to FIG. 6, the shrouded turbine 200 includes a turbine shroud 210, a nacelle body 250, a rotor 239, and an ejector shroud 220. The turbine shroud 210 includes a front end 212, also known as an inlet end or a leading edge. The turbine shroud 210 also includes a rear end 216, also known as an exhaust end or trailing edge. The ejector shroud 220 includes a front end, inlet end or leading edge 222, and a rear end, exhaust end, or trailing edge 224. Support members 206 are shown connecting the turbine shroud 210 to the ejector shroud 220.

The rotor 239 is operatively associated with the nacelle body 250. The rotor 239 includes a central hub 241 at the proximal end of one or more rotor blades 240 and defines a rotor plane where the fluid flow intersects the blades 240. The central hub 241 is rotationally engaged with the nacelle body 250. The nacelle body 250 and the turbine shroud 210 are supported by a tower 202. In the present embodiment, the rotor 239, turbine shroud 210, and ejector shroud 220 are coaxial with each other, i.e. they share a common central axis 205.

Referring to FIG. 7. The turbine shroud 210 has the cross sectional shape of an airfoil with the suction side (i.e. low pressure side) on the interior of the shroud. The rear end 216 of the turbine shroud also has mixing lobes including rotor flow (low energy) mixing lobes 215 and bypass flow (high energy) mixing lobes 217. The mixing lobes extend downstream beyond the rotor blades 240. Put another way, the trailing edge 216 of the turbine shroud is shaped to form two different sets of mixing lobes. High energy mixing lobes 217 extend inwardly towards the central axis 205 of the mixer shroud. Low energy mixing lobes 215 extend outwardly away from the central axis 205. An opening in the sidewall 219 between the low energy lobe 215 and the high energy mixing lobe 217 increases mixing between high and low energy streams.

A mixer-ejector pump is formed by the ejector shroud 220 in fluid communication with the ring of high energy mixing lobes 217 and low energy mixing lobes 215 on the turbine shroud 210. The mixing lobes 217 extend downstream toward the inlet end 222 of the ejector shroud 220. This mixer-ejector pump provides the means for increased operational efficiency. The area of higher velocity fluid flow is generally depicted by the shaded area 245 (FIG. 7). In accordance with the present disclosure, rotor blades in a mixer-ejector turbine may be designed appropriately to take advantage of the energy transfer as a result of the mixing between the bypass flow and the rotor wake flow. This mixing is strongly determined by the height and shape of the lobes 215 and 217.

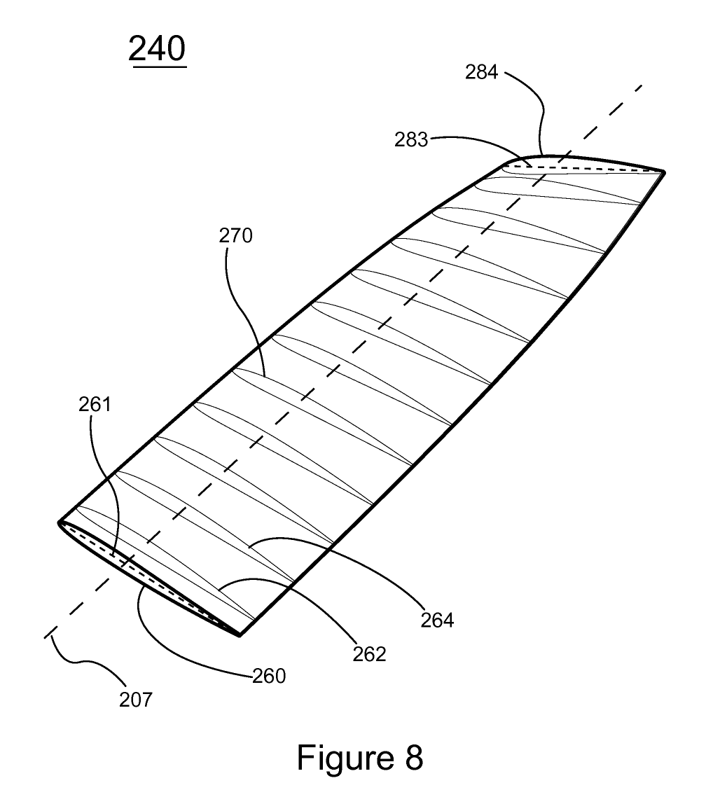

Referring to FIG. 8-10, an example rotor blade 240 (e.g., for the mixer-ejector turbine 200 of FIGS. 6-7) is shown. The blade 240, advantageously includes a power-extracting region adapted for radially-varied (relative to the axis of rotation) power extraction per mass flow rate. Cross sections 260, 262, 264 . . . 284 are delineated at different radial positions relative to the axis of rotation (e.g., relative to axis 205 of FIGS. 6-7) along the central axis 207 of the blade. Each cross section 260, 262, 264, . . . , 284 represents a station along the blade 240 and defines an airfoil. According to the illustrated embodiment, each airfoil may be characterized based on the length and pitch of a cord between the leading and trailing edges of the airfoil (note this is merely an illustrative embodiment, however, and any number of parameters relating to the shape and/or pitch of the airfoil may be identified and used to characterize the airfoil). Cross section 260 defines chord 261. Similarly, cross section 284 defines chord 283.

In one example embodiment, the rotor blade 240 may be constructed and/or modeled using multiple blade segments, e.g., such as defined between cross sections, wherein each blade segment actually has or is assumed to have a constant airfoil shape and pitch (e.g., a constant chord length and chord pitch). In this embodiment, the airfoil shape and/or pitch of one segment need not be contiguous with the airfoil shape and/or pitch of an adjacent segment. In another example embodiment, the rotor blade 240 may be constructed and/or modeled as a contiguous structure, e.g., wherein the shape and pitch of the airfoil changes contiguously with respect to radial-position. Thus, for example, the rotor blade 240 may be modeled as an infinite number of blade segments of a width (dr) approaching zero. Analysis of forces and/or structural parameters can be achieved by integrating over a length of the blade 240 (0 to R).

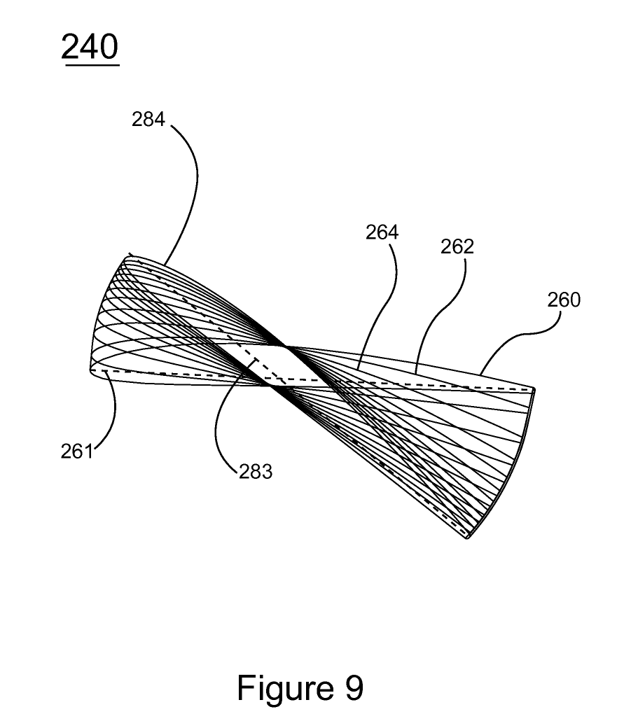

Referring to FIG. 9, each chord has a length and a pitch as seen in the length and relative pitch angle between chords 261 and 283. Airfoil characteristics, such as the chord length and pitch of each cross section affect the loading on the blade at the corresponding station. Thus, for blade 240, the pitch and/or shape of the airfoil at a first cross section, e.g., cross section 284, is configured, so that the power extraction per mass flow rate of the blade 240 at that first cross section is different than the power extraction per mass flow rate of the blade 240 at a second cross section, e.g., cross section 260. Blade 240 is advantageously configured to take advantage of the non-uniform flow profile resulting from the mixer-ejector pump of the turbine 200 of FIGS. 6-7 with greater loading toward the tip to take advantage of the region of greater fluid flow velocity (shaded area 245 of FIG. 7). Blade 240 illustrates how a power-extracting region of an unevenly loaded blade may optimized for an expected relative flow velocity between fluid flow at a first radial position and fluid flow at a second radial position. In example embodiments, the power-extracting region of an unevenly loaded blade may optimized based on optimal lift/drag ratios for each radial position such as a maximal lift/drag ratio prior to stall or prior to a selected safety threshold. As illustrated by blade 240, the greater the relative flow velocity at a radial position, the greater the optimal lift/drag ratio at that position and the greater the power extraction per mass flow rate at that position. In an example embodiment, relative flow velocity between two radial positions may be related, for example, proportional to relative power extraction per mass flow rate between the two radial positions.

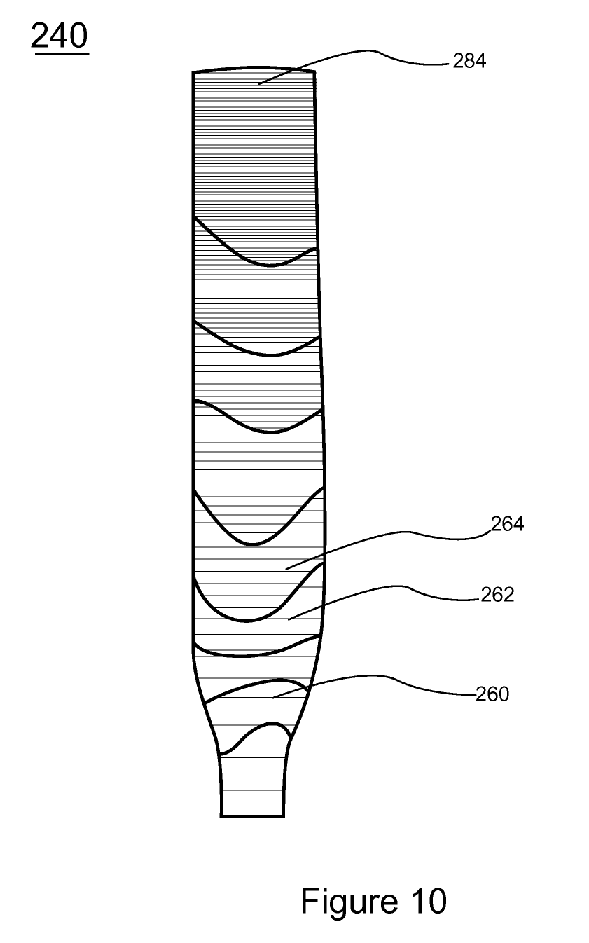

FIG. 10, depicts blade loading (Δp) across different regions of the blade 240. Blade loading (Δp) is illustrated using horizontal hash markings wherein the spacing between the hash markings is inversely proportional to blade loading. As depicted in FIG. 10, blade 240 is designed to have uneven blade loading at each station across a power-extracting region of the blade 240 when operating in the fluid stream of turbine 200 of FIGS. 6-7. More particularly, blade 240 is configured to exhibit greater loading toward the tip to take advantage of the region of greater fluid flow velocity. Note that for the embodiment depicted in FIG. 4 the power-extracting region includes portions of the blade from cross section 260 to cross section 284, e.g., there are no non-power extracting regions toward the tip or root.

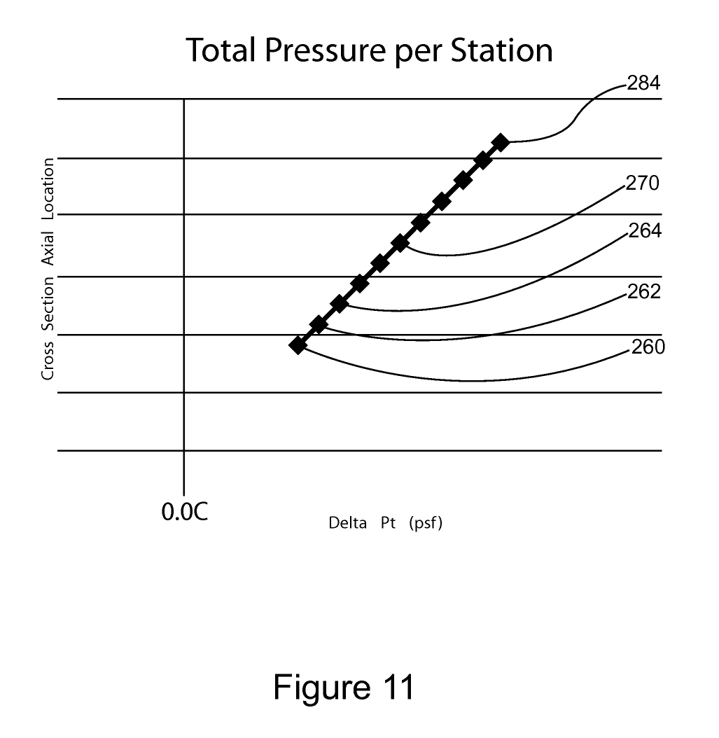

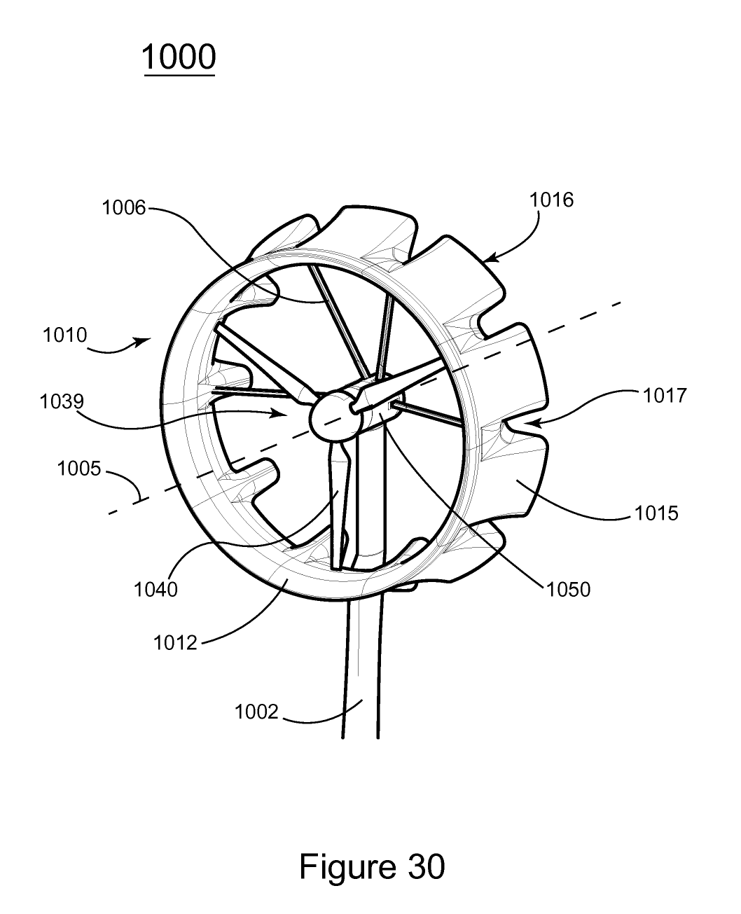

FIG. 11 depicts a graphical representation of blade loading per station as represented in FIG. 10 for blade 240. As noted with respect to FIG. 10 uneven blade loading is evident for stations of the blade 240 (see, e.g., the gradual decrease in blade loading from station 284 to station 260). The position of cross sections 260, 262, 264 . . . 284 along the central blade axis 207 is represented along the vertical axis of the graph. Blade loading, characterized by a pressure differential (Δp) in pounds per square foot (psf) is represented along the horizontal axis of the graph. In some embodiments, the load at a station that represents the blade tip (cross section 284) is between 20% and 45% greater than the load at a mean section (cross section 270), similarly, the load at a station that represents the blade root (cross section 260) is 20% to 45% lower than that of the mean section (cross section 270). It is noted that mixer/ejector turbine 200 of FIGS. 6-7 is only one example of a shrouded turbine which may be used in accordance with the apparatus, systems and methods of the present disclosure to produce a non-uniform flow profile across a rotor plane. Indeed, other implementations of shrouded turbines, e.g., with or without an ejector shroud and/or with or without mixing lobes may also be used instead to produce non-uniform flow profile across a rotor plane. See, for example, FIGS. 30-32, depicting further exemplary shrouded turbine embodiments capable of producing a non-uniform flow profile across a rotor plane.

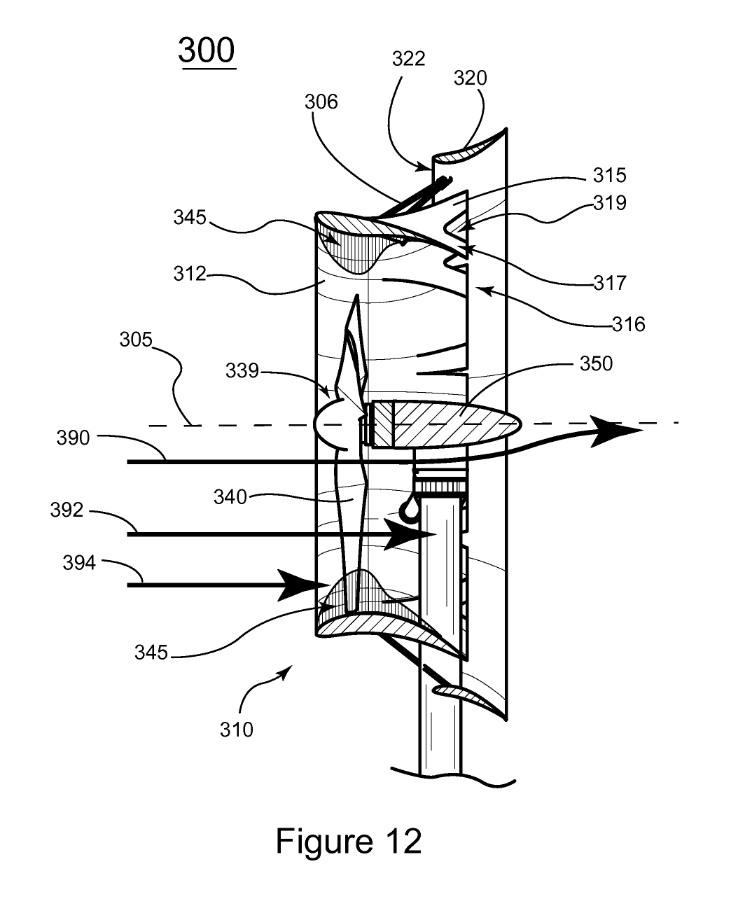

FIG. 30 is a perspective view of a further example embodiment of a shrouded turbine 1000 including a turbine shroud 1010 characterized by a ringed airfoil. Unlike the turbine 200 of FIGS. 6-7, turbine 1000 does not include an ejector shroud. Turbine 1000 also includes a nacelle body 1050 and a rotor 1039 including a plurality of rotor blades 1040. Unlike the turbine 200 of FIGS. 6-7, turbine 1000 in the embodiment of FIG. 12 does not include an ejector shroud. The turbine shroud 1010 advantageously induces a non-uniform flow profile across a rotor plane. Turbine shroud 1010 further includes mixing elements 1015 and 1017. Mixing elements 1015 and 1017 include inward turning mixing elements 1017 which turn inward toward a central axis 1005 and outward turning mixing elements 1015 which turn outward from the central axis 1005. The turbine shroud 1010 includes a front end 1012 also known as an inlet end or a leading edge. Mixing elements 1015 and 1017 include a rear end 1016, also known as an exhaust end or trailing edge. Support structures 1006 are engaged at the proximal end, with the nacelle body 1050 and at the distal end with the turbine shroud 1010. The rotor 1039, nacelle body 1050, and turbine shroud 1010 are concentric about a common axis 1005 (which is the axis of rotation for the rotor 1039) and are supported by a tower structure 1002.

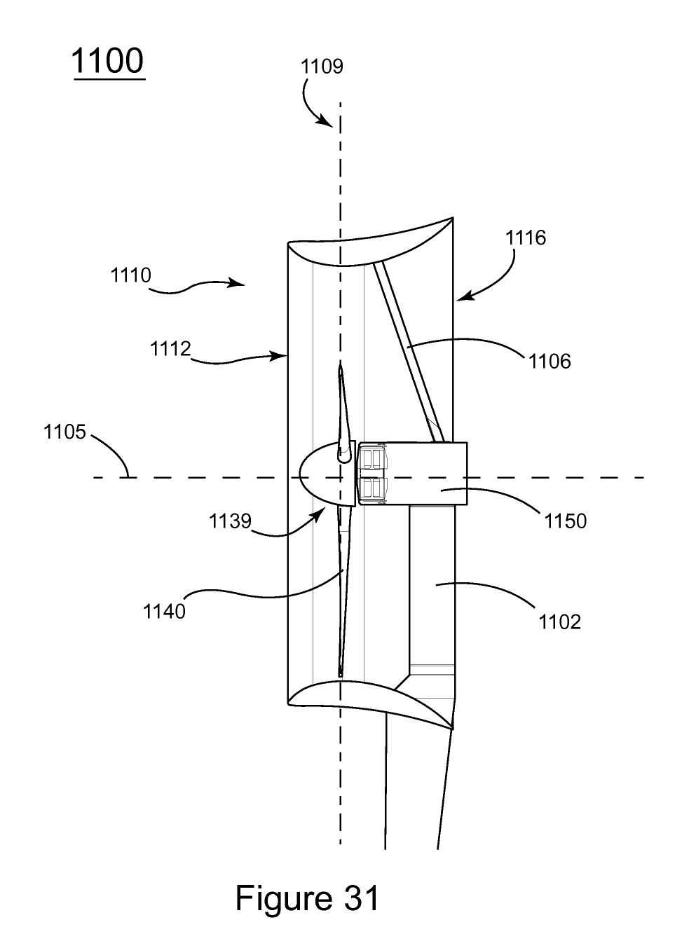

FIG. 31 depicts a cross section view of a further example embodiment of a shrouded turbine 1100. Turbine 1100 includes a shrouded turbine 1110 characterized by a ringed airfoil. Turbine 1100 also includes a nacelle body 1150 and a rotor 1139 including a plurality of rotor blades 1140. Similar to the turbine 1000 of FIG. 30, the turbine 1100 depicted in FIG. 31 does not include an ejector shroud. The turbine shroud 1110 advantageously induces a non-uniform flow profile across a rotor plane 1109. Unlike the turbine shroud 1010 in FIG. 30, the turbine shroud 1110 in the embodiment of FIG. 31, does not include mixing elements. The turbine shroud 1110 includes a front end 1112 also known as an inlet end or a leading edge and a rear end 1116, also known as an exhaust end or trailing edge. Support structures 1106 are engaged at a proximal end with the nacelle body 1150 and at the distal end with the turbine shroud 1110. The rotor 1139, nacelle body 1150, and turbine shroud 1110 are concentric about a common axis 1105 (which is the axis of rotation for the rotor 1139) and are supported by a tower structure 1102.

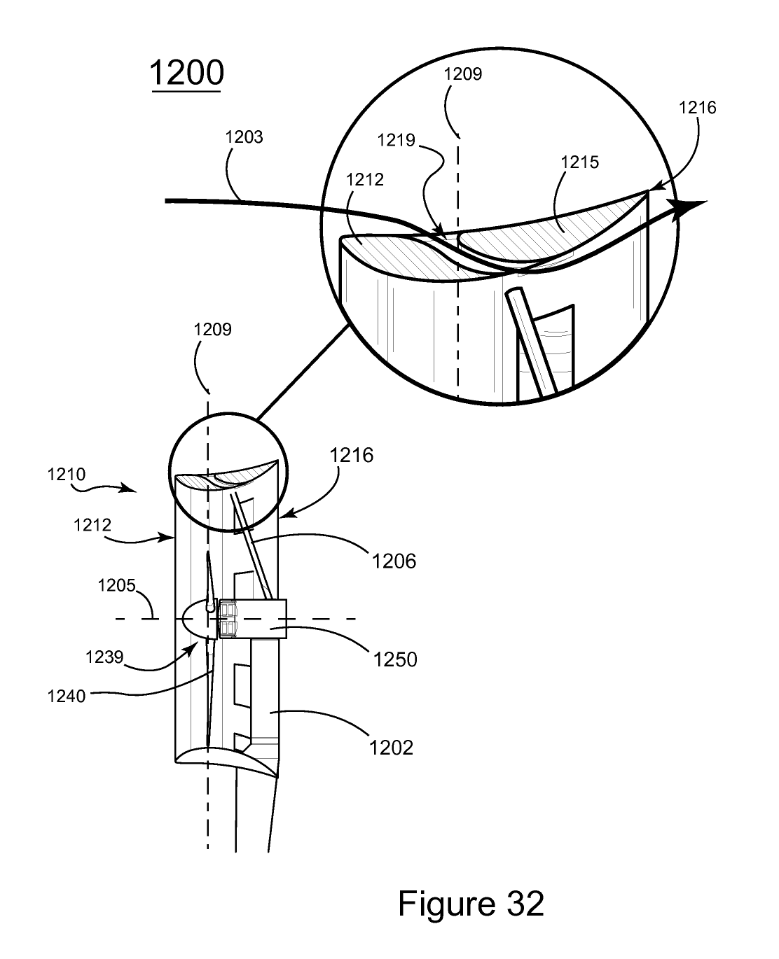

FIG. 32 depicts a cross section view of a further example embodiment of a shrouded turbine 1200. Turbine 1200 includes a shrouded turbine 1210 characterized by a ringed airfoil. Turbine 1200 also includes a nacelle body 1250 and a rotor 1239 including a plurality of rotor blades 1240. Similar to the turbines 1000 and 1100 of FIGS. 30-31, the turbine 1200 depicted in FIG. 32 does not include an ejector shroud. The turbine shroud 1210 advantageously induces a non-uniform flow profile across a rotor plane 1209. Instead of including mixing lobes, turbine shroud 1210 advantageously defines a plurality of passages 1219 extending from the outer surface to the inner surface of the turbine shroud 1210. Passages 1219 act as bypass ducts that providing mixing between a bypass flow 1203 and the fluid flow through the turbine 1200 down-stream from the rotor plane 1209 thus introducing a volume of high energy flow to the exit flow. The turbine shroud 1210 includes a front end 1212 also known as an inlet end or a leading edge and a rear end 1216, also known as an exhaust end or trailing edge. Support structures 1206 are engaged at a proximal end with the nacelle body 1250 and at the distal end with the turbine shroud 1210. The rotor 1250, nacelle body 1250, and turbine shroud 1210 are concentric about a common axis 1205 (which is the axis of rotation for the rotor 1250) and are supported by a tower structure 1202.

It is contemplated that a turbine shroud may not be the only mechanism in a turbine for inducing a non-uniform flow profile across a rotor plane of a turbine. Indeed, any appropriate mechanism may be used to manipulate fluid flow instead of or in addition to a turbine shroud.

FIG. 12 is a perspective view of a further exemplary embodiment of a shrouded turbine 300. Turbine 300 includes a turbine shroud 310, a nacelle body 350, a rotor 339, and an ejector shroud 320. The turbine shroud 310 includes a front end 312, also known as an inlet end or a leading edge. The turbine shroud 310 also includes a rear end 316, also known as an exhaust end or trailing edge. The ejector shroud 320 includes a front end, inlet end or leading edge 322 and a rear end, exhaust end or trailing edge 324. Support members 306 are shown connecting the turbine shroud 310 to the ejector shroud 320.

The rotor 339 is operatively associated with the nacelle body 350. The rotor 339 includes a central hub 341 at the proximal end of one or more rotor blades 340 and defines a rotor plane where the fluid flow intersects the blades 340. The central hub 341 is rotationally engaged with the nacelle body 350. The nacelle body 350 and the turbine shroud 310 are supported by a tower 302. In the present embodiment, the rotor 339, turbine shroud 310, and ejector shroud 320 are coaxial with each other, i.e. they share a common central axis 305.

The turbine shroud 310 has the cross-sectional shape of an airfoil with the suction side (i.e. low pressure side) on the interior of the shroud. The rear end 316 of the turbine shroud also has mixing lobes including rotor flow (low energy) mixing lobes 315 and bypass flow (high energy) mixing lobes 317. The mixing lobes extend downstream beyond the rotor blades 340. Put another way, the trailing edge 316 of the turbine shroud is shaped to form two different sets of mixing lobes. High energy mixing lobes 317 extend inwardly towards the central axis 305 of the mixer shroud. Low energy mixing lobes 315 extend outwardly away from the central axis 305. An opening in the sidewall 319 between the low energy lobe 315 and the high energy mixing lobe 317 increases mixing between high and low energy streams.

A mixer-ejector pump is formed by the ejector shroud 320 in fluid communication with the ring of high energy mixing lobes 317 and low energy mixing lobes 315 on the turbine shroud 310. The mixing lobes 317 extend downstream toward the inlet end 322 of the ejector shroud 320. This mixer-ejector pump provides the means for increased operational efficiency. The area of higher velocity fluid flow is generally depicted by the shaded area 345. In accordance with the present disclosure, rotor blades in a mixer-ejector turbine may be designed appropriately to take advantage of the energy transfer as a result of the mixing between the bypass flow and the rotor wake flow. This mixing is strongly determined by the height and shape of the mixing lobes 315 and 317.

Airflow through the rotor plane is represented by arrows 390, 392 and 394. Rotor blades 340 are advantageously designed to include a first region configured for extracting power from a fluid flow and a second region configured for adding power to the fluid flow. The power extracted from the fluid flow is typically greater than the power generated into the fluid flow resulting in a net power extracted for the blades 340. In one embodiment, the blades 340 may be designed to extract power from a fluid stream along 70%-80% of their length while adding power to a fluid stream along 20%-30% of their length. As depicted in FIG. 12, blades 340 are designed to include a first region proximal to the root of the blades 340 for adding power to the fluid flow, thereby increasing flow through the center of the turbine. Air flowing along the nacelle 350, represented by arrow 390, can have a tendency to separate from the laminar flow area along the surface of the nacelle 350. Increasing the flow over the nacelle controls the laminar flow. The rotor blades 340 are configured to add power to the fluid flow 390, which may also be described as accelerating the fluid flow, in the root region, and extract power from the fluid flow 394 in the tip region, with a transition region proximal to fluid flow 392. The flow 394 in the top ⅓ portion of the rotor 339 passes through the low energy lobes 315 and is quickly energized by the bypass flow. Any swirl set up by the rotor power extraction is reduced by the lobe arrangement such that the lobes serve as flow straighteners. One skilled in the art will readily recognize that the power extraction profile of an unevenly loaded rotor 339 may alternatively be such that the rotor is designed to extract energy from the fluid flow 390 passing the root region of the blades and add energy to the fluid flow 394 passing the tip region of the blades. Moreover, one skilled in the art will readily recognize that blade designs may or may not include a transition region (e.g., the region of fluid flow 392) between an energy extraction region and an energy injection region.

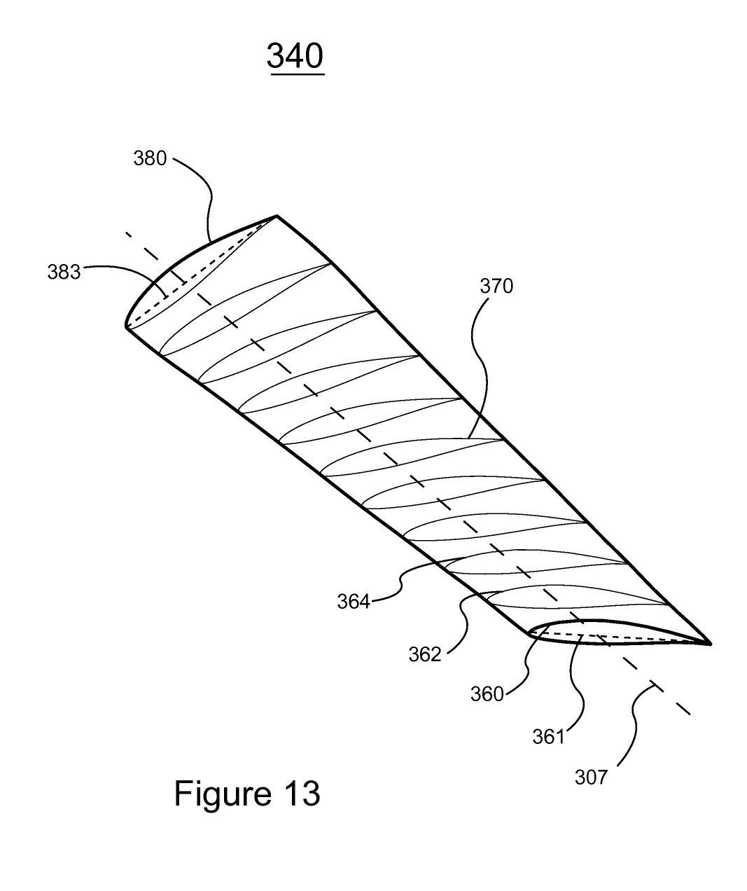

Referring to FIG. 13-15, an example rotor blade 340 (e.g. for the mixer-ejector turbine 300 of FIG. 12) is depicted. The blade 240, advantageously includes both a power-extracting region for extracting power from a fluid flow and a power injecting region for adding power to, or accelerating, a fluid flow. Cross-sections 360, 362, 364 . . . 380 are delineated at different radial positions relative to the axis of rotation (e.g., relative to axis 303 of FIG. 12) along the central axis 307 of the blade. Each cross-section 360, 362, 364 . . . 380 represents a station along the blade 240 and defines an airfoil. According to the illustrated embodiment, each airfoil may be characterized based on the length and pitch of a cord between the leading and trailing edges of the airfoil (note this is merely an illustrative embodiment, however, and any number of parameters relating to the shape and/or pitch of the airfoil may be identified and used to characterize the airfoil). Cross-section 360 defines chord 361. Similarly, cross-section 380 defines chord 383.

In one example embodiment, the rotor blade 340 may be constructed and/or modeled using multiple blade segments, e.g., such as defined between cross sections, wherein each blade segment actually has, or is assumed to have, a constant airfoil shape and pitch (e.g., a constant chord length and chord pitch). In this embodiment, the airfoil shape and/or pitch of one segment need not be contiguous with the airfoil shape and/or pitch of an adjacent segment. In another example embodiment, the rotor blade 340 may be constructed and/or modeled as a contiguous structure, (e.g., assuming the shape and pitch of the airfoil change contiguously with respect to radial-position). Thus, for example, the rotor blade 340 may be modeled as an infinite number of blade segments of a width (dr) approaching zero. Analysis of forces and/or structural parameters can be achieved by integrating over a length of the blade 340 (0 to R).

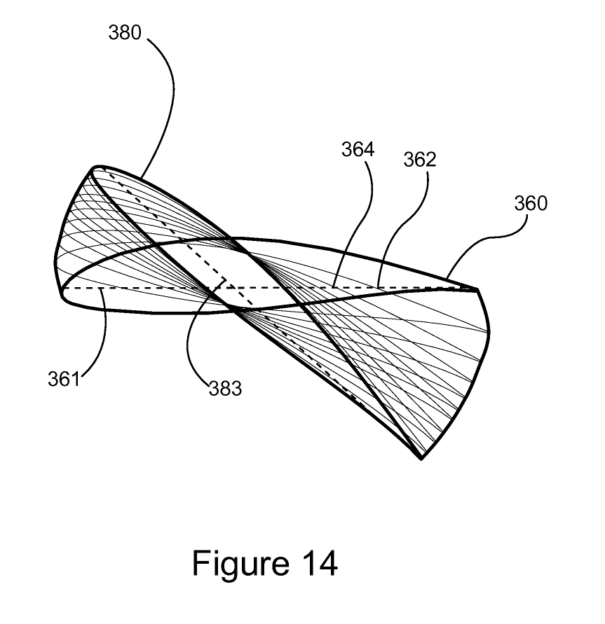

Referring to FIG. 14, each chord has a length and a pitch as seen in the length and relative pitch angle between chords 361 and 383. The chord length and pitch of each cross-section affects the loading on the blade at the corresponding station. Airfoil characteristics, such as the chord length and pitch of each cross section affect the loading on the blade at the corresponding station. Thus, for blade 340, the pitch and/or shape of the airfoil at a first cross section, e.g., cross section 380, is configured, extract power from a flow (or in other words, have a positive load) and the pitch and/or shape of the airfoil at a second cross section, e.g., cross section 360, is configured to add power to a flow (or in other words, have a negative load). In the embodiment depicted, the rotor blade 340 is configured to add power to a flow, using a region near the root of the blade 340 and extract power from a flow using a remaining power-extracting region of the blade 340. The illustrated unevenly loaded blade 340 of the present embodiment is not intended to be limiting in scope and one skilled in the art will readily recognize that the negative and positive loading may be located at a plurality of regions along the length of the blade 340.

In an example embodiment, a power-extracting region of the blade 340 may be unevenly loaded, i.e., adapted for radially-varied (relative to the axis of rotation) power extraction per mass flow rate. Thus, blade 340 may be advantageously configured to take advantage of the non-uniform flow profile resulting from the mixer-ejector pump of the turbine 300 of FIG. 12 with greater loading toward the tip to take advantage of the region of greater fluid flow velocity (shaded area 345 of FIG. 12). Blade 340 illustrates how a power-extracting region of an unevenly loaded blade may optimized or otherwise adjusted for an expected relative flow velocity between fluid flow at a first radial position and fluid flow at a second radial position. In example embodiments, the power-extracting region of an unevenly loaded blade may be adjusted or optimized based on optimal lift/drag ratios for each radial position such as a high or a maximal lift/drag ratio prior to stall or prior to a selected safety threshold. As illustrated by blade 340, the greater the relative flow velocity at a radial position, the greater the optimal lift/drag ratio at that position and the greater the power extraction per mass flow rate at that position. In an example embodiment, relative flow velocity between two radial positions may be related, for example, proportional to relative power extraction per mass flow rate between the two radial positions.

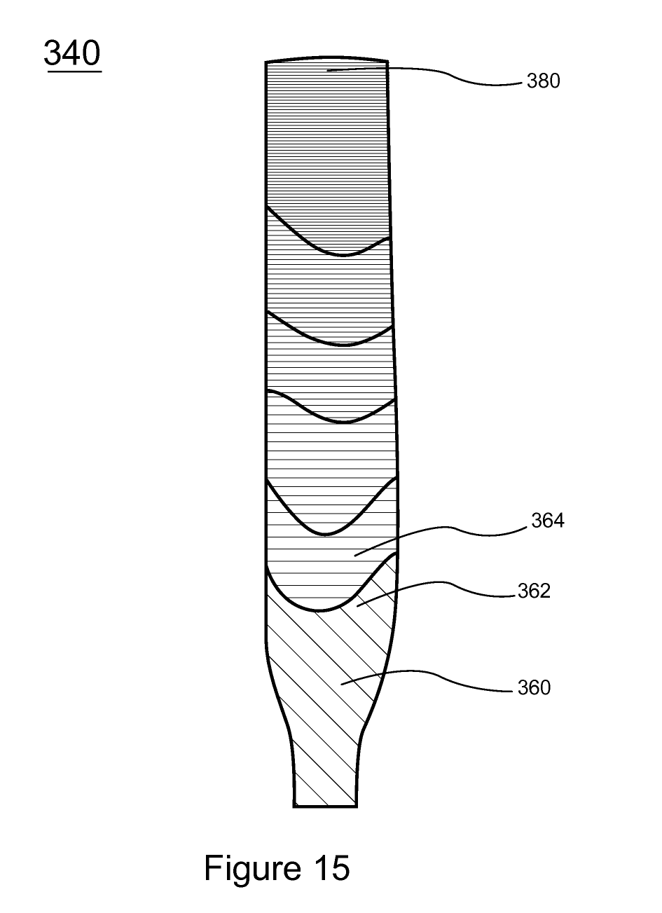

FIG. 15, depicts blade loading (Δp) across different regions of the blade 340. Blade loading (Δp) is illustrated using horizontal hash markings to illustrate a region of positive loading (power extraction) and diagonal hash markings to illustrate a region of negative loading (power injection). With respect to the power-extracting region, the spacing between the hash markings is inversely proportional to blade loading. As depicted in FIG. 15, blade 340 is designed to have a region of negative loading (cross sections 360 and 362) proximal to the root of the blade 340. Moreover, as depicted in FIG. 15, blade 340 is designed to have uneven blade loading at each station across a power-extracting region of the blade 340 when operating in the fluid stream of turbine 300 of FIG. 12. More particularly, the power extracting region is configured to exhibit greater loading toward the tip to take advantage of the region of greater fluid flow velocity. Note that for the embodiment depicted in FIG. 15 the power-extracting region includes portions of the blade (e.g., cross section 364 through cross section 380) beyond a transition region. Note that in the illustrated embodiment there are no non-power extracting regions toward the tip.

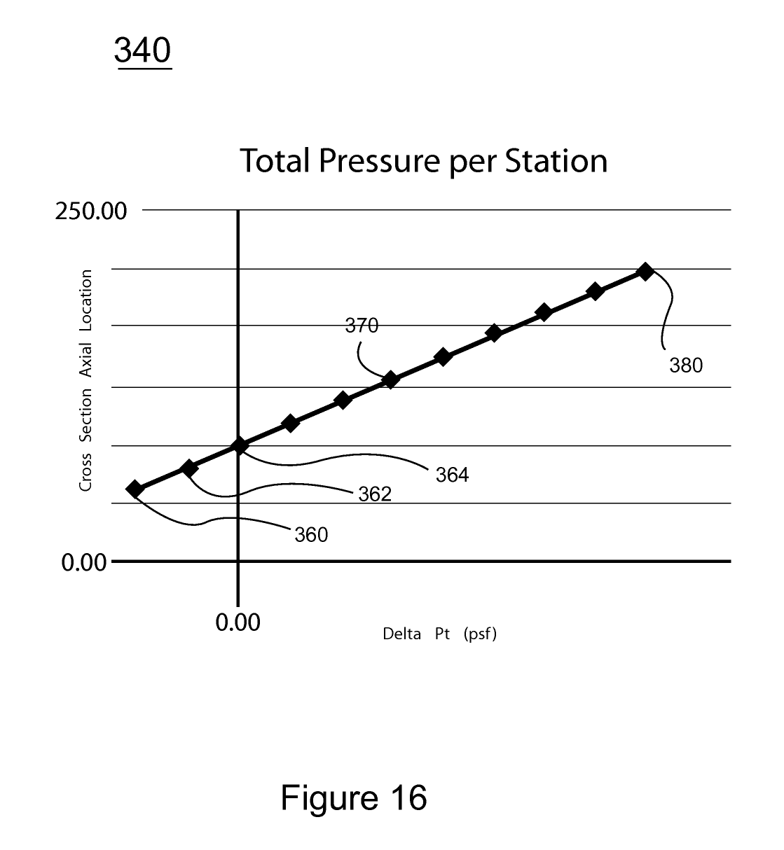

FIG. 16 depicts a graphical representation of blade loading per station as represented in FIG. 15 for blade 340. As noted with respect to FIG. 10, negative loading is evident for stations of the blade 340 proximal to the root (see, e.g., cross sections 360 and 362). Moreover, uneven blade loading is evident for stations of the blade 240 in a power-extracting region (see, e.g., the gradual decrease in blade loading from station 380 to at least station 370). The position of cross sections 360, 362, 364 . . . 380 along the central blade axis 307 is represented along the vertical axis of the graph. Blade loading, characterized by a pressure differential (Δp) in pounds per square foot (psf) is represented along the horizontal axis of the graph.

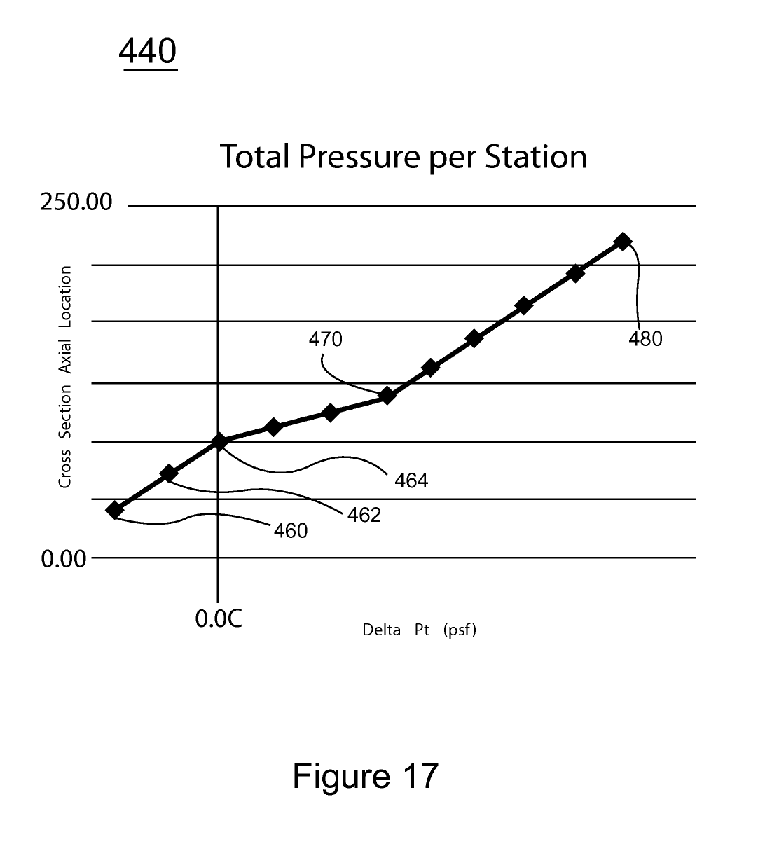

FIG. 16 depicts a graphical representation of blade loading per station for a further exemplary blade 440. Again, negative loading is evident for stations of the blade 440 proximal to the root (see, e.g., cross sections 460 and 462). Moreover, uneven blade loading is evident for stations of the blade 240 in a power-extracting region (see, e.g., the gradual decrease in blade loading from station 480 to station 470). The position of cross sections 360, 362, 364 . . . 380 along is represented along the vertical axis of the graph. Blade loading, characterized by a pressure differential (Δp) in pounds per square foot (psf) is represented along the horizontal axis of the graph. Note that FIG. 17 illustrates a transition region (sections 464-470) characterized by a sharper change in blade loading relative to a power-extracting region (sections 470-480) of the blade 440.

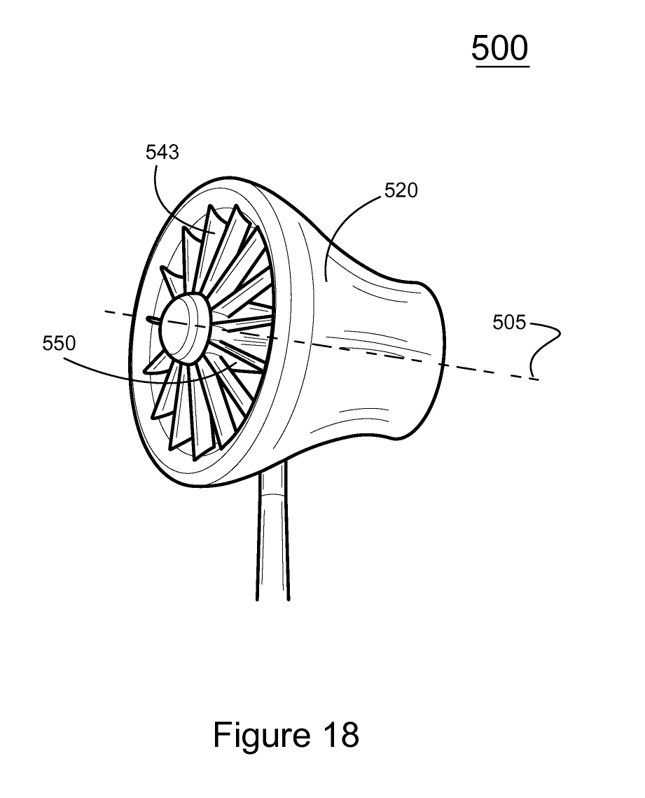

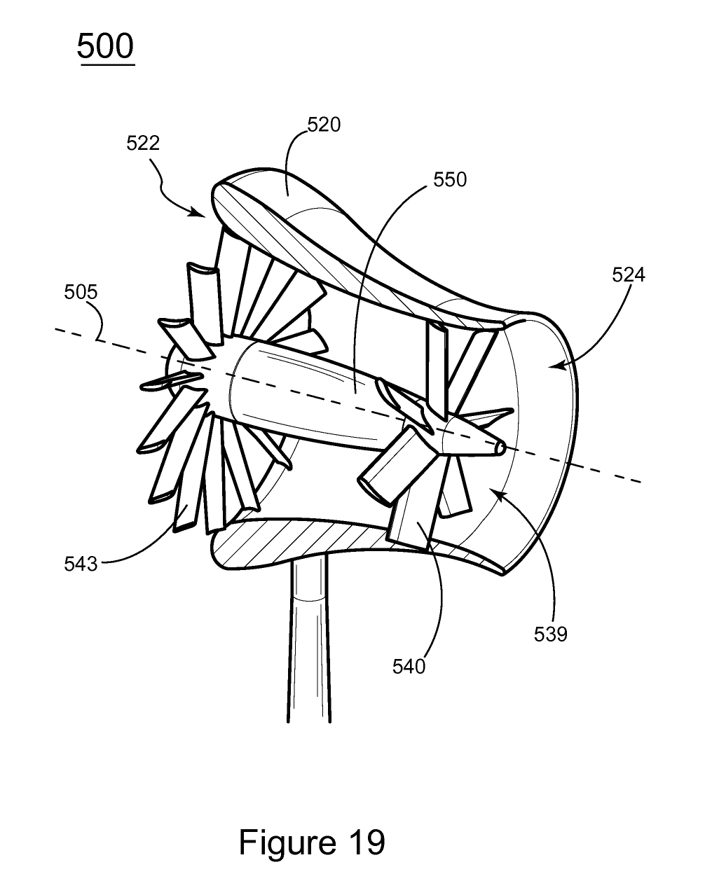

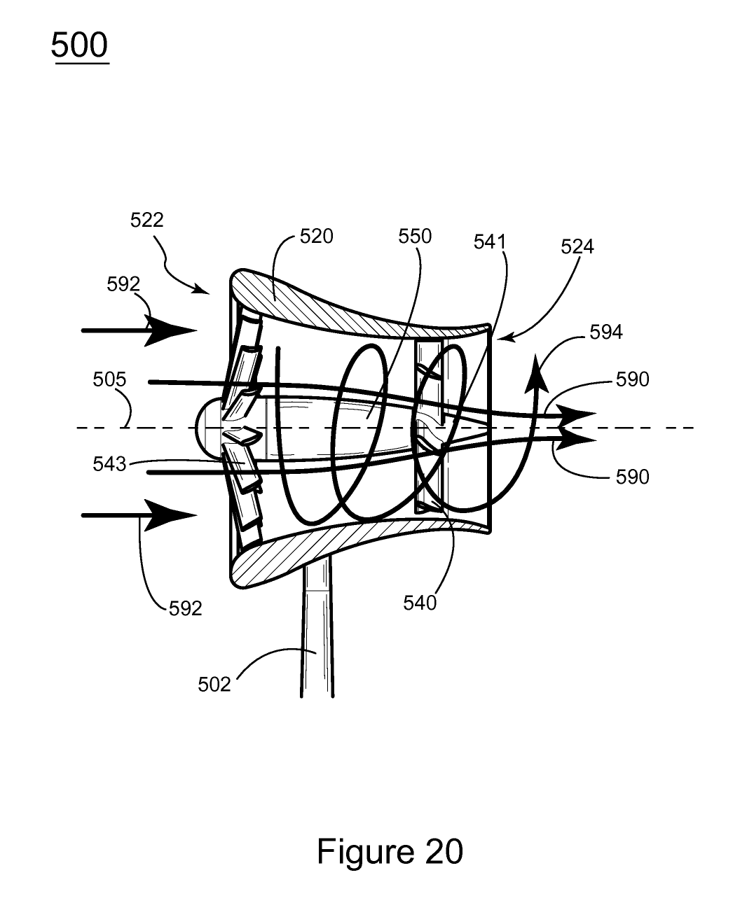

FIG. 18 is a perspective view of a further exemplary embodiment of a shrouded turbine 500 according to the present disclosure. FIG. 19 is a perspective, partial cross-sectional view of the shrouded turbine 500 of FIG. 18. FIG. 20 is a side cross-sectional view illustrating the airflow through the turbine 500 of FIGS. 18-19. Referring to FIGS. 18-20, the shrouded turbine 500 includes a turbine shroud 520, a nacelle body 550, a rotor 539 including one or more rotor blades 540, and an array of swirl-vanes 543. The turbine shroud 520 includes a front end 522, also known as an inlet end or a leading edge and also includes a rear end 524, also known as an exhaust end or trailing edge.

The rotor 539 is positioned proximal to or surrounding the nacelle body 250. The rotor 539 includes a central hub 541 at the proximal end of the rotor blades 540. The central hub 541 is rotationally engaged with the nacelle body 550. The nacelle body 250 and the turbine shroud 520 are supported by a tower 502. In the present embodiment, the rotor 539, turbine shroud 520, and array of swirl-vanes 543 are coaxial with each other, (i.e. they share a common central axis 505, which is also the axis of rotation for the rotor 539).

As illustrated by FIG. 18-20 the turbine shroud 520 may have the cross-sectional shape of an airfoil with the suction side (i.e., low pressure side) on the interior of the shroud. Swirl-vanes 543 initiate a rotational swirl in the fluid stream, represented by arrow 594 at the inlet side 522. The rotational vortices in the fluid stream 594 disperse and mix with the ambient air as it leaves the exit 524.

This rotational fluid motion enhances the power output of the system by increasing the velocity of the fluid stream at the rotor plane for more power availability, and by reducing pressure on a down-stream side of the rotor plane. Note that the rotational fluid motion results in a non-uniform flow velocity profile across the rotor plane with regions of higher velocity proximal to interior surface of the shroud.

The swirl of the fluid stream within the turbine shroud 520 creates a cyclonic effect (represented by arrow 594) providing greater velocity along the interior walls of the turbine shroud 520. Due to a narrowing of the turbine shroud 520, the velocity of the cyclonic fluid flow 594 increases as it approaches the rotor 539 (i.e., the swirled stream 594 increases in velocity as the fluid flows from the inlet 522 to the exhaust 524). The area of highest velocity fluid flow across the rotor plane is generally toward the tips of the blades 540. In accordance with the present disclosure, rotor blades 540 may be designed appropriately to take advantage of the energy transfer as a result of the cyclonic flow 594.

Air flowing along the nacelle 550, represented by arrow 590, can have a tendency to separate from the laminar flow area along the surface of the nacelle 550. Increasing the flow over the nacelle controls the laminar flow. The blades 540 are designed to add power to the fluid flow 590 in the region root region, and extract energy from fluid flow 594 in the tip region. One skilled in the art will readily recognize that blade designs may or may not include a transition region between an energy extraction region and an energy injection region.

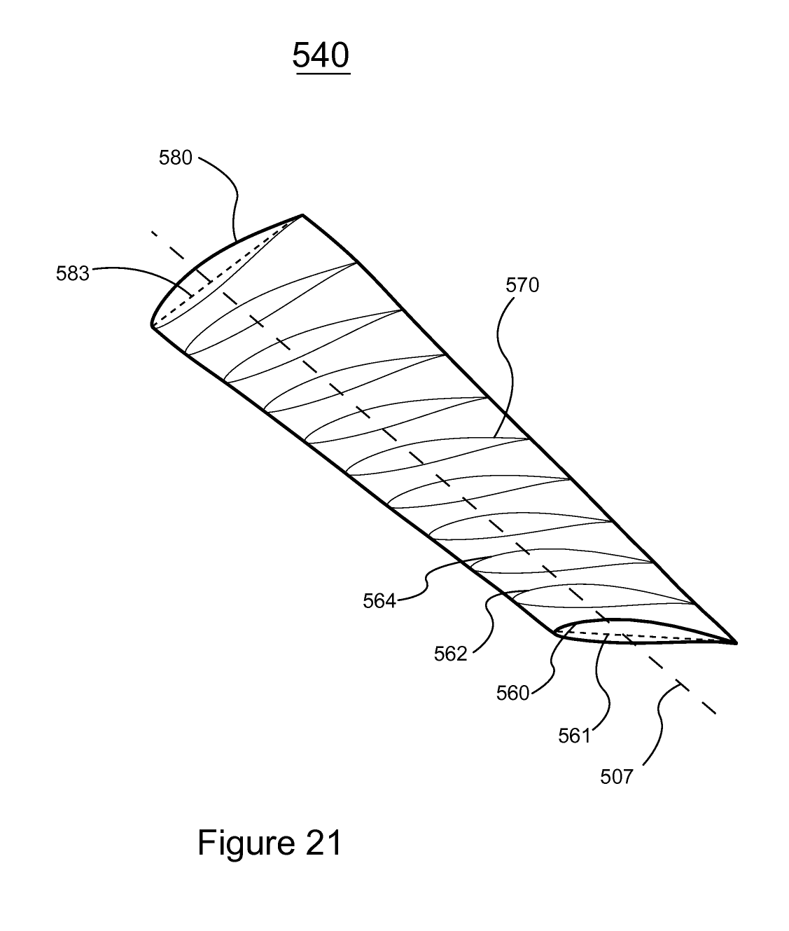

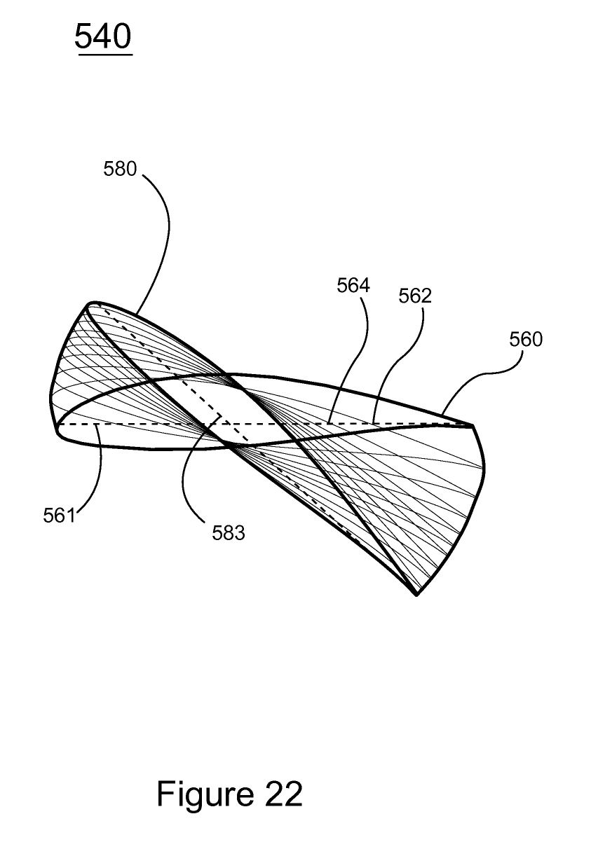

Referring to FIG. 21-22, an example rotor blade 540 (e.g., for the shrouded turbine 500 of FIGS. 18-20) is depicted. The blade 540, advantageously includes both a power-extracting region for extracting power from a fluid flow and a power injecting region for adding power to a fluid flow. Cross sections 560, 562, 564 . . . 580 are delineated at different radial positions relative to the axis of rotation (e.g., relative to axis 505 of FIGS. 18-20) along the central axis 507 of the blade. Each cross section 560, 562, 564 . . . 580 represents a station along the blade 540 and defines an airfoil. According to the illustrated embodiment, each airfoil may be characterized based on the length and pitch of a cord between the leading and trailing edges of the airfoil (note this is merely an illustrative embodiment, however, and any number of parameters relating to the shape and/or pitch of the airfoil may be identified and used to characterize the airfoil). Cross section 560 defines chord 561. Similarly, cross section 580 defines chord 583.

In one example embodiment, the rotor blade 540 may be constructed and/or modeled using multiple blade segments (e.g., such as defined between cross sections), where each blade segment actually has, or is assumed to have, a constant airfoil shape and pitch (e.g., a constant chord length and chord pitch). In this embodiment, the airfoil shape and/or pitch of one segment need not be contiguous with the airfoil shape and/or pitch of an adjacent segment. In another example embodiment, the rotor blade 540 may be constructed and/or modeled as a contiguous structure, e.g., wherein the shape and pitch of the airfoil changes contiguously with respect to radial-position. Thus, for example, the rotor blade 540 may be modeled as an infinite number of blade segments of a width (dr) approaching zero. Analysis of forces and/or structural parameters can be achieved by integrating over a length of the blade 540 (0 to R).

Referring to FIG. 22, each chord has a length and a pitch as seen in the length and relative pitch angle between chords 561 and 583. Airfoil characteristics, such as the chord length and pitch of each cross section affect the loading on the blade at the corresponding station. Thus, for blade 540, the pitch and/or shape of the airfoil at a first cross section, e.g., cross section 580, is configured, extract power from a flow (or in other words, have a positive load) and the pitch and/or shape of the airfoil at a second cross section, e.g., cross section 560, is configured to add power to a flow (or in other words, have a negative load). In the embodiment depicted, the rotor blade 540 is designed to add power to a flow, using a region near the root of the blade 540 and extract power from a flow using a remaining power-extracting region of the blade 540. The illustrated unevenly loaded blade 540 of the present embodiment is not intended to be limiting in scope and one skilled in the art will readily recognize that the negative and positive loading may be located at a plurality of regions along the length of the blade 540.

In an example embodiment, a power-extracting region of the blade 540 may be unevenly loaded, (i.e., configured for power extraction per mass flow rate that varies radially relative to the axis of rotation). Thus, blade 540 may be advantageously configured to take advantage of the non-uniform flow profile resulting from the cyclonic airflow of the turbine 500 of FIGS. 18-20 with greater loading toward the tip to take advantage of the region of greater fluid flow velocity. Blade 540 illustrates how a power-extracting region of an unevenly loaded blade may be configured for, or optimized for, an expected relative flow velocity between fluid flow at a first radial position and fluid flow at a second radial position. In example embodiments, the power-extracting region of an unevenly loaded blade may configured based on desired, specified or optimal lift/drag ratios for each radial position such as a maximal lift/drag ratio prior to stall or prior to a selected safety threshold. As illustrated by blade 540, the greater the relative flow velocity at a radial position, the greater the potential lift/drag ratio at that position and the greater the power extraction per mass flow rate at that position. In an example embodiment, relative flow velocity between two radial positions may be related, for example, proportional to relative power extraction per mass flow rate between the two radial positions.

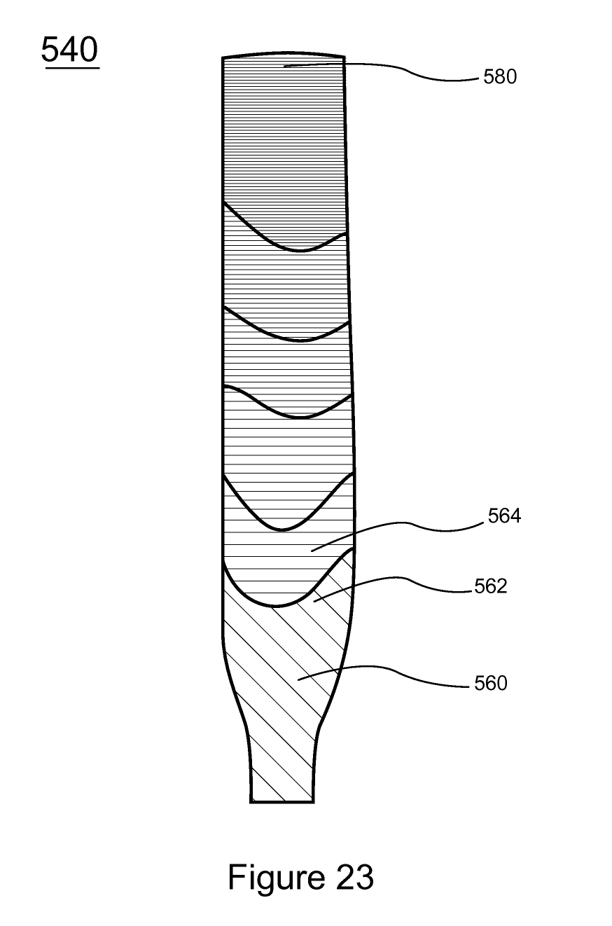

FIG. 23, depicts blade loading (Δp) across different regions of the blade 540. Blade loading (Δp) is illustrated using horizontal hash markings to illustrate a region of positive loading (power extraction) and diagonal hash markings to illustrate a region of negative loading (power injection). With respect to the power-extracting region, the spacing between the hash markings is inversely proportional to blade loading. As depicted in FIG. 23, blade 540 is designed to have a region of negative loading (cross sections 560 and 562) proximal to the root of the blade 540. Moreover, as depicted in FIG. 23, blade 540 is designed to have uneven blade loading at each station across a power-extracting region of the blade 540 when operating in the fluid stream of turbine 500 of FIGS. 18-20. More particularly, the power extracting region is configured to exhibit greater loading toward the tip to take advantage of the region of greater fluid flow velocity. Note that for the embodiment depicted in FIG. 23 the power-extracting region includes portions of the blade (e.g., cross section 564 through cross section 580) beyond a transition region. Note that in the illustrated embodiment there are no non-power extracting regions toward the tip.

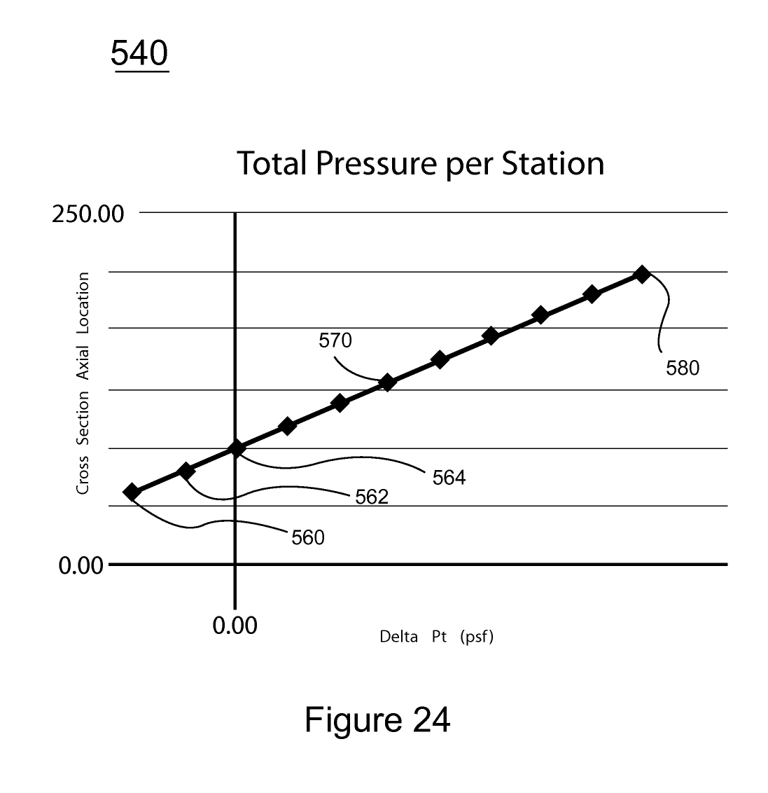

FIG. 24 depicts a graphical representation of blade loading per station as represented in FIG. 23 for blade 540. As noted with respect to FIG. 23, negative loading is evident for stations of the blade 540 proximal to the root (see, e.g., cross sections 560 and 562). Moreover, uneven blade loading is evident for stations of the blade 540 in a power-extracting region (see, e.g., the gradual decrease in blade loading from station 580 to at least station 570). The position of cross sections 560, 562, 564 . . . 580 along the central blade axis 507 is represented along the vertical axis of the graph. Blade loading, characterized by a pressure differential (Δp) in pounds per square foot (psf) is represented along the horizontal axis of the graph.

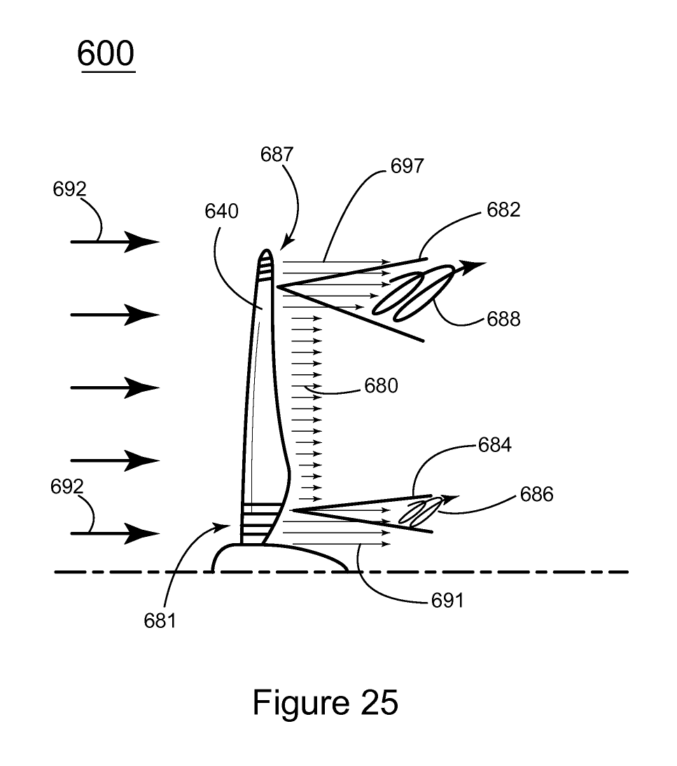

Referring to FIG. 25, a partial section view of an exemplary turbine blade 640 is depicted. The effect of mixed blade loading (e.g., partially positive and partially negative) of the blade 640 is illustrated. A uniform velocity oncoming fluid stream is represented by arrows 692. In the embodiment depicted, the rotor blade 640 includes a root region 681 and a tip region 682 that are designed to add power to the fluid stream 692. The effect of the rotor blade 640 on the fluid stream 692, down-stream from the rotor plane, is represented by arrows 697, 680, 691, 686 and 688. More particularly, arrows 697 and 691 represents flow with power added to fluid stream 692 by the tip region 687 and root region 681, respectively. Arrows 680 represent flow with power extracted from fluid stream 692 by a power extraction region of the blade 640. Mixing vortices 688 and 686 occur in areas 682 and 684, respectively (between the power extracted flow 680 and each of the power added flows 697 and 691). Advantageously, as a result of power added flows 697 and 691, the mixing vortices 688 and 686 occur further downstream than they would without the power added flows thereby mitigating the effects of the mixing vortices on blade operation.

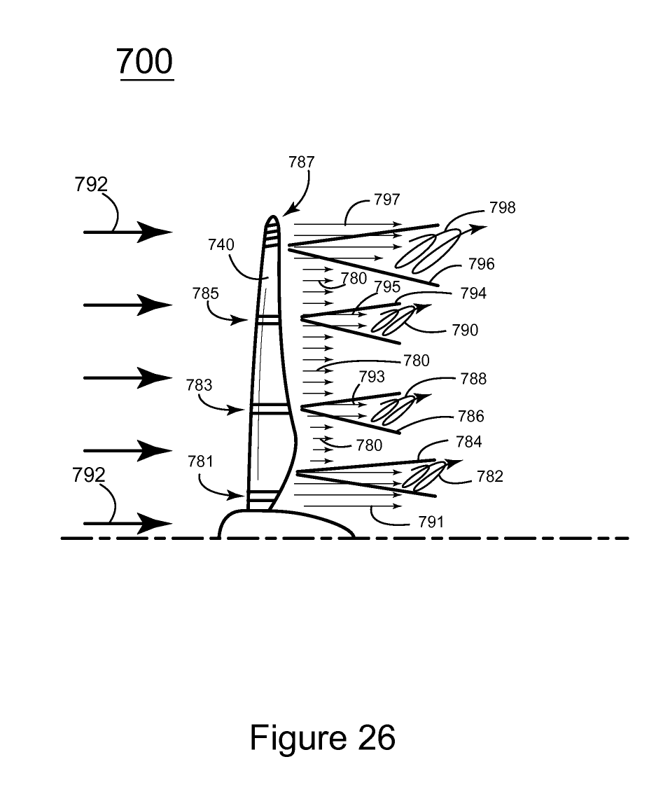

Referring to FIG. 26, a partial section view of a further exemplary turbine blade 740 is depicted. The effect of mixed blade loading (e.g., partially positive and partially negative) of the blade 740 is illustrated. A uniform velocity oncoming fluid stream is represented by arrows 792. In the embodiment depicted, the rotor blade 740 includes a root region 781, a tip region 782 and two mid regions 783,785 that are configured to add power to (or accelerate) the fluid stream 792. The effect of the rotor blade 742 on the fluid stream 792, down-stream from the rotor plane, is represented by arrows 797, 795, 793, 791, 780, 798, 790, 788 and 782. More particularly, arrows 797, 795, 793 and 791 represent flow with power added to fluid stream 792 by the tip region 787, mid regions 783 and 785 and root region 781, respectively. Arrows 780 represent flow with power extracted from fluid stream 792 by power extraction regions of the blade 740. Mixing vortices 798, 790, 788 and 782 occur in areas 796, 794, 786 and 784, respectively (between the power extracted flow 780 and each of the power added flows 797, 795, 793 and 791). Advantageously, as a result of power added flows 797, 795, 793 and 791, the mixing vortices 798, 790, 788 and 782 occur further downstream than they would without the power added flows thereby mitigating the effects of mixing vortices on blade operation.

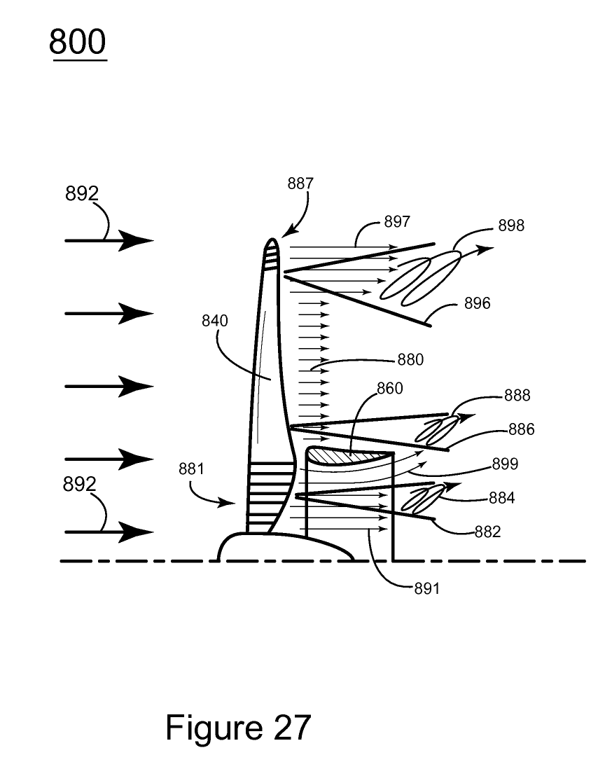

Referring to FIG. 27, a partial section view of an exemplary turbine blade 840 is depicted. The effect of mixed blade loading (e.g., partially positive and partially negative) of the blade 840 is illustrated. A uniform velocity oncoming fluid stream is represented by arrows 892. In the embodiment depicted, the rotor blade 840 includes a root region 881 and a tip region 882 that are designed to add power to the fluid stream 892. The effect of the rotor blade 840 on the fluid stream 892 down-stream from the rotor plane, is represented by arrows 897, 880, 891, 886 and 888. More particularly, arrows 897 and 891 represent flow with power added to fluid stream 892 by the tip region 887 and root region 881, respectively. Arrows 880 represent flow with power extracted from fluid stream 892 by a power extraction region of the blade 840. Mixing vortex 886 occurs in area 896 (between the power extracted flow 880 and the power added flow 897). Advantageously, as a result of power added flow 897, the mixing vortex 886 occurs further downstream than it would without the power added flows thereby mitigating the effects of the mixing vortex on blade operation. In the embodiment of FIG. 27 a shroud 860 is included proximal to the trailing edge of the rotor blade 840. The shroud 860 defines a ringed airfoil having a suction side on an interior side of the shroud 840. Increased velocity flow occurs over the surface of the airfoil, represented by arrows 899. Mixing occurs between the relatively higher velocity flow 899 and the flow 891, represented by the cone shaped area 882 with mixing vortices 884. Mixing also occurs between the trailing edge flow 880 and the increased velocity flow 899, represented by cone shaped area 886 with mixing vortices 888.

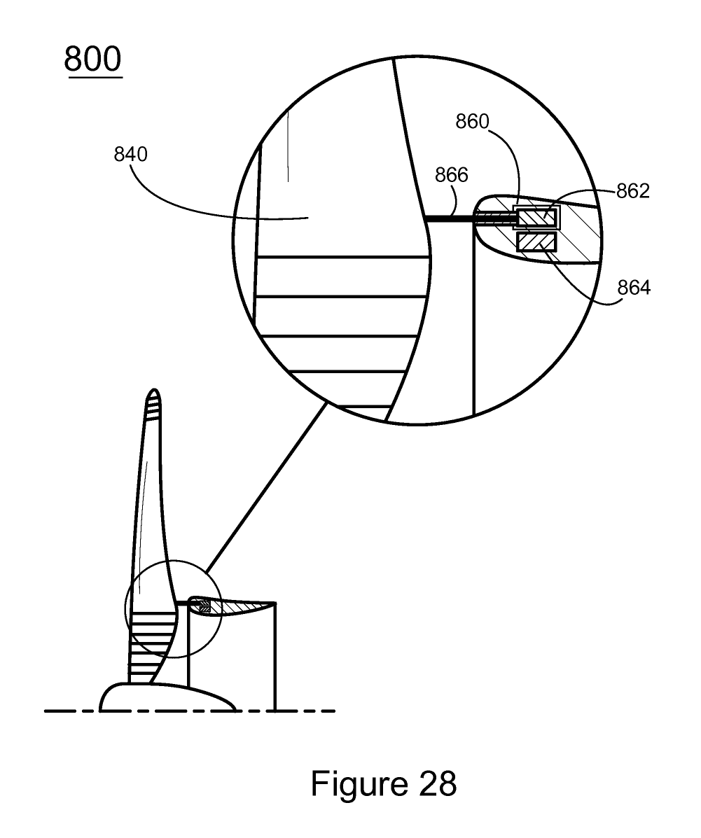

Referring to FIG. 28, an exploded view of the turbine blade 840 and shroud 860 of FIG. 27 is shown. The shroud 860 provides a housing for a ringed generator comprising an array of permanent magnets, 864 and coils 862. A shaft engages the rotor blade 840 with the array of coils 862 for the purpose of generating electricity.

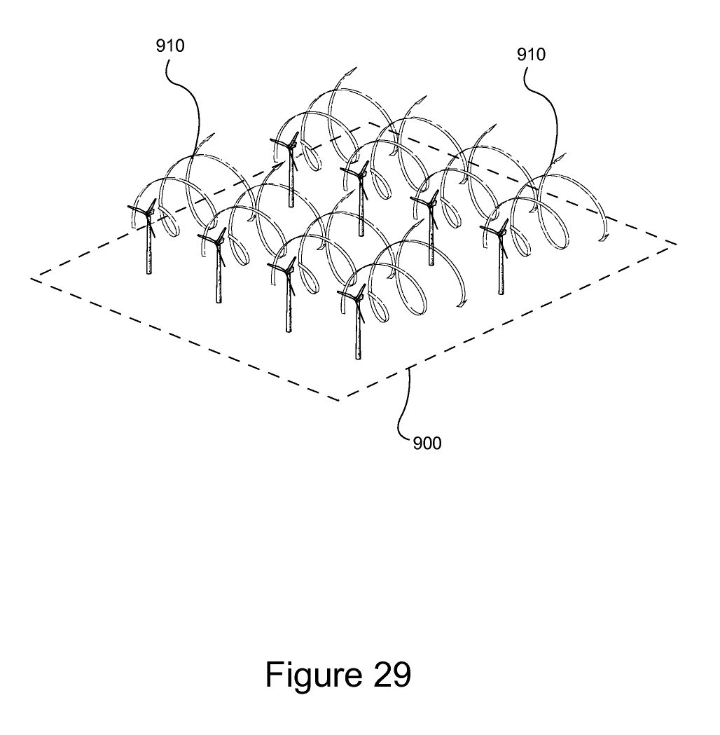

Referring to FIG. 29, a turbine park 900 including a plurality of turbines is depicted. The wind turbine park illustrates one advantage of mixing vortices 910 produced using mixed blade loading, for example, as described with respect to FIGS. 25-27. In particular, the mixing vortices 910 enable faster mixing of fluid flow downstream of a turbine thereby improving performance for downstream turbines (shorter wake). This enables fitting a greater number of turbines in the turbine park 900.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A turbine comprising a rotor that includes at least one turbine blade having a first region configured for adding power to a fluid flow and a second region configured for extracting power from the fluid flow.

2. The turbine of claim 1, wherein the turbine blade is configured so that the power extracted from the fluid flow is greater than the power added to the fluid flow.

3. The turbine of claim 1, wherein the first region of the blade constitutes no more than about 30% of a total length of the blade.

4. The turbine of claim 1, wherein the first region is configured so that the power added to the fluid flow provides distributed mixing of wake and tip vortices.

5. The turbine of claim 1, wherein the first region comprises a tip region of the blade.

6. The turbine of claim 1, wherein the first region comprises a root region of the blade.

7. The turbine of claim 1, wherein the first region is configured to control the laminar flow around a nacelle of the turbine.

8. The turbine of claim 1, wherein the blade is configured to include a transition region of reduced blade loading between the first and second regions.

9. The turbine of claim 1, wherein an airfoil of the blade at the first region is configured based on a pitch or a shape to affect a negative blade loading and an airfoil of the blade at the second region is configured based on a pitch or a shape to affect a positive blade loading.

10. The turbine of claim 1, wherein the second region is an unevenly loaded power-extracting region configured to extract energy from a non-uniform fluid velocity profile across a rotor plane such that power extraction per mass flow rate at a first radial position relative to an axis of rotation is different than power extraction per mass flow rate at a second radial position relative to the axis of rotation.

11. The turbine of claim 10, wherein an airfoil of the blade at each of the first and second radial positions is configured based on a pitch or a shape of the airfoil to affect the difference between power extraction per mass flow rate at the first radial position and power extraction per mass flow rate at the second radial position.

12. The turbine of claim 10, wherein the non-uniform velocity profile includes a greater flow velocity at the first radial position than at the second radial position and wherein power extraction per mass flow rate at the first radial position is greater than power extraction per mass flow rate at the second radial position.

13. The turbine of claim 10, wherein the power-extracting region of the blade is configured based on an expected relative flow velocity between fluid flow at the first radial position and fluid flow at the second radial position.

14. The turbine of claim 13, wherein the power-extracting region is configured based on specified lift/drag ratios for the first and second radial positions.

15. The turbine of claim 12, wherein each specified lift/drag ratio is one of (i) a maximal lift/drag ratio prior to stall and (ii) a maximal lift/drag ratio prior to a selected safety threshold.

16. The turbine of claim 10, wherein the non-uniform fluid velocity profile across the rotor plane is induced by the turbine.

17. The turbine of claim 16, further comprising a turbine shroud, wherein the non-uniform flow velocity profile across the rotor plane is created, in part, by the turbine shroud.

18. The turbine of claim 17, wherein the turbine shroud includes one or more mixing devices disposed downstream of the rotor and extending downstream.

19. The turbine of claim 17 further comprising an ejector shroud downstream of the turbine shroud.

20. The turbine of claim 19, wherein the turbine shroud with one or more mixing devices and the ejector shroud form a mixer-ejector pump, and wherein the non-uniform flow velocity profile at the rotor plane is created, in part, by the mixer-ejector pump.

21. The turbine of claim 16 further comprising an array of swirl-vanes, wherein the non-uniform flow velocity profile across the rotor plane is created, in part, by the swirl-vanes generating a cyclonic airflow.

22. The turbine of claim 1 further comprising a shroud downstream of the rotor configured to inject additional power into at least a portion of the fluid flow exiting the first region of the blade.

23. A rotor blade for a turbine, the rotor blade comprising a first region configured for adding power to a fluid flow and a second region configured for extracting power from the fluid flow.

24. The blade of claim 23, wherein the turbine blade is configured so that the power extracted from the fluid flow is greater than the power added to the fluid flow.

25. The blade of claim 23, wherein the first region of the turbine blade constitutes no more than about 30% of a total length of the blade.

26. The blade of claim 23, wherein the first region is configured so that the power added to the fluid flow provides distributed mixing of wake and tip vortices.

27. The blade of claim 23, wherein the first region comprises a tip region of the blade.

28. The blade of claim 23, wherein the first region comprises a root region of the blade.

29. The blade of claim 23, wherein the first region is configured to control the laminar flow around a nacelle of the turbine.

30. The blade of claim 23, wherein the blade comprises transition region of minimal blade loading between the first and second regions.

31. The blade of claim 23, wherein an airfoil of the blade at the first region is configured based on a pitch or a shape to affect a negative blade loading and an airfoil of the blade at the second region is configured based on a pitch or a shape to affect a positive blade loading.

32. The blade of claim 23, wherein the second region is an unevenly loaded power-extracting region configured to extract energy from a non-uniform fluid velocity profile such that power extraction per mass flow rate at a first radial position relative to an axis of rotation is different than power extraction per mass flow rate at a second radial position relative to the axis of rotation.

33. The blade of claim 32, wherein an airfoil of the blade at each of the first and second radial positions is configured based on a pitch or a shape of the airfoil to affect the difference between power extraction per mass flow rate at the first radial position and power extraction per mass flow rate at the second radial position.

34. The turbine of claim 32, wherein the non-uniform velocity profile includes a greater flow velocity at the first radial position than at the second radial position and wherein power extraction per mass flow rate at the first radial position is greater than power extraction per mass flow rate at the second radial position.

35. The turbine of claim 32, wherein the power-extracting region of the blade is configured for an expected relative flow velocity between fluid flow at the first radial position and fluid flow at the second radial position.

36. The turbine of claim 35, wherein the power-extracting region is configured based on specified lift/drag ratios for the first and second radial positions.

37. The turbine of claim 36, wherein each specified lift/drag ratio is one of (i) a maximal lift/drag ratio prior to stall and (ii) a maximal lift/drag ratio prior to a selected safety threshold.

38. A shrouded axial flow fluid turbine comprising:
an aerodynamically contoured turbine shroud having an inlet and configured to produce a non-uniform fluid velocity profile across a rotor plane when exposed to a fluid flow; and
a rotor disposed downstream of the inlet and configured to extract energy from fluid passing through the rotor plane, the rotor comprising:
a central hub; and
a plurality of blades, each blade including:
a root region having a blade root;
a tip region having a blade tip;
a mid-region disposed between the root region and the tip region; and
a blade axis extending radially from the blade root to the blade tip;
each blade configured to have a value of power extraction per mass flow rate at a radial position along the blade axis that is greater at a first radius in the tip region of the blade than at second radius in the mid-region of the blade when exposed to the non-uniform fluid velocity profile, and each blade configured to accelerate a fluid flowing past the root region of the blade.

39. An axial flow fluid turbine comprising:
an aerodynamically contoured turbine shroud having an inlet and configured to produce a non-uniform fluid velocity profile across a rotor plane when exposed to a fluid flow; and
a rotor disposed downstream of the turbine shroud inlet and configured to extract energy from fluid passing through the rotor plane, the rotor comprising:
a central hub having a central axis of rotation; and
a plurality of blades, each blade including:
a root region including a blade root;
a tip region including a blade tip;
a mid-region disposed between the root region and the tip region; and
a blade axis extending from the blade root to the blade tip;
wherein each blade is configured to have a positive value of power extraction per mass flow rate averaged over radial positions along the blade axis in the tip region and a negative value of power extraction per mass flow rate averaged over radial positions along the blade axis in the root region when exposed to the non-uniform fluid velocity profile.

40. A rotor blade coupleable to a rotor of a shrouded fluid turbine having a turbine shroud that produces a non-uniform fluid velocity profile across a rotor plane when exposed to a fluid flow, the rotor including a central hub configured to receive one or more rotor blades, the rotor blade comprising:
a root region having a blade root;
a tip region having a blade tip;
a mid-region disposed between the root region and the tip region; and
a blade axis extending from the blade root to the blade tip;
wherein the blade is configured to, when connected with the central hub, have a positive value of power extraction per mass flow rate averaged over radial positions along the blade axis in the tip region and a negative value of power extraction per mass flow rate averaged over radial positions along the blade axis in the root region when exposed to the non-uniform fluid velocity profile.

41. A method of operating a shrouded axial flow fluid turbine including an aerodynamically contoured turbine shroud having an inlet, and a rotor disposed downstream of the turbine shroud inlet, the rotor including a plurality of blades, each blade having a root region including a blade root, a tip region including a blade tip, and a mid-region disposed between the root region and the tip region, the method comprising:
establishing a non-uniform fluid flow through a rotor plane in which an average velocity of fluid flowing through an area of the rotor plane associated with the tip region of each blade is greater than an average velocity of fluid flowing through an area of the rotor plane associated with the mid-region of each blade;
injecting power into the non-uniform fluid flow in an area of the rotor plane associated with the root region of each blade by accelerating fluid flow using the root region of each blade; and
extracting power from the non-uniform fluid flow using the plurality of blades by extracting a greater average power per mass flow rate over the tip region of each blade than an average power per mass flow rate extracted over the a mid-region of each blade.
